(19) United States
(12) Patent Application Publication
(10) Pub. No.: US 2025/0174707 A1
(43) Pub. Date: May 29, 2025

(54) Lithium Battery Pack Comprising Internally Connected Unit Cells and Production Method

(71) Applicant: Honecomb Battery Company, Dayton, OH (US)

(72) Inventors: Kailash Patil, Dayton, OH (US); Xingang Zhao, Dayton, OH (US); Hao-Hsun Chang, Centerville, OH (US); Bor Z. Jang, Centerville, OH (US)

(73) Assignee: Honeycomb Battery Company, Dayton, OH (US)

(21) Appl. No.: 18/522,642

(22) Filed: Nov. 29, 2023

(51) Int. Cl. H01M 10/052; H01M 4/02; H01M 4/62; H01M 4/70; H01M 10/04; H01M 10/0562; H01M 10/0565; H01M 10/42; H01M 50/204

(52) U.S. Cl. CPC H01M 10/052; H01M 4/62; H01M 4/622; H01M 4/628; H01M 4/70; H01M 10/0468; H01M 10/0562; H01M 10/0565; H01M 10/4235; H01M 50/204; H01M 2004/021; H01M 2300/0068; H01M 2300/0082

(57) ABSTRACT

A lithium battery pack, comprising one or more than one battery module wherein each module comprises a plurality of unit cells that are internally connected in series and wherein each unit cell comprises a positive electrode (PE), a negative electrode (NE), an ion-conducting separator layer (SL) disposed between the positive electrode and the negative electrode. The modules are made by stacking and connecting PE, SL, and NE layers to form a stack in a layer-by-layer, electrode-separator-electrode, or unit cell-by-unit cell manner. Preferably, a pressure and/or heat is applied to the stack for a period of time to consolidate the stack for forming the modules, which may be encased by a protective housing member to obtain a pack.

### FIELD

The present invention provides a lithium battery module or pack containing multiple battery unit cells that are internally connected in series and/or in parallel, and manufacturing methods for the battery module or pack.

### BACKGROUND

Rechargeable lithium-ion (Li-ion) and lithium metal batteries (e.g., lithium-sulfur, lithium selenium, and Li metal-air batteries) are considered promising power sources for electric vehicle (EV), hybrid electric vehicle (HEV), and portable electronic devices, such as lap-top computers and mobile phones. Lithium as a metal member has the highest lithium storage capacity (3,861 mAh/g) compared to any other metal or metal-intercalated compound as an anode active material (except Li_{4.4}Si, which has a specific capacity of 4,200 mAh/g). Hence, in general, Li metal batteries (having a lithium metal anode) have a significantly higher energy density than lithium-ion batteries (having a graphite anode).

However, the electrolytes used for lithium-ion batteries and all lithium metal secondary batteries pose some safety concerns. Most of the organic liquid electrolytes can cause thermal runaway or explosion problems.

Ionic liquids (ILs) are a new class of purely ionic, salt-like materials that are liquid at unusually low temperatures. The official definition of ILs uses the boiling point of water as a point of reference: “Ionic liquids are ionic compounds which are liquid below 100° C.”. A particularly useful and scientifically interesting class of ILs is the room temperature ionic liquid (RTIL), which refers to the salts that are liquid at room temperature or below. RTILs are also referred to as organic liquid salts or organic molten salts. An accepted definition of an RTIL is any salt that has a melting temperature lower than ambient temperature.

Although ILs were suggested as a potential electrolyte for rechargeable lithium batteries due to their non-flammability, conventional ionic liquid compositions have not exhibited satisfactory performance when used as an electrolyte likely due to several inherent drawbacks: (a) ILs have relatively high viscosity at room or lower temperatures; thus being considered as not amenable to lithium ion transport; (b) For Li—S cell uses, ILs are capable of dissolving lithium polysulfides at the cathode and allowing the dissolved species to migrate to the anode (i.e., the shuttle effect remains severe); and (c) For lithium metal secondary cells, most of the ILs strongly react with lithium metal at the anode, continuing to consume Li and deplete the electrolyte itself during repeated charges and discharges. These factors lead to relatively poor specific capacity (particularly under high current or high charge/discharge rate conditions, hence lower power density), low specific energy density, rapid capacity decay and poor cycle life. Furthermore, ILs remain extremely expensive. Consequently, as of today, no commercially available lithium battery makes use of an ionic liquid as the primary electrolyte component.

Solid state electrolytes are commonly believed to be safe in terms of fire and explosion proof. Solid state electrolytes can be divided into organic, inorganic, organic-inorganic composite electrolytes. However, the conductivity of organic polymer solid state electrolytes, such as poly(ethylene oxide) (PEO), polypropylene oxide (PPO), poly(ethylene glycol) (PEG), and poly(acrylonitrile) (PAN), is typically low (<10⁻⁵ S/cm).

Although the inorganic solid-state electrolyte (e.g., garnet-type and metal sulfide-type) can exhibit a high conductivity (about 10⁻³ S/cm), the interfacial impedance or resistance between the inorganic solid-state electrolyte and the electrode (cathode or anode) is high. Further, the traditional inorganic ceramic electrolyte is very brittle and has poor film-forming ability and poor mechanical properties. These materials cannot be cost-effectively manufactured. Although an organic-inorganic composite electrolyte can lead to a reduced interfacial resistance, the lithium ion conductivity and working voltages may be decreased due to the addition of the organic polymer.

The applicant's research group has previously developed the quasi-solid state electrolytes (QSSE), which may be considered as a fourth type of solid state electrolyte. In certain variants of the quasi-solid state electrolytes, a small amount of liquid electrolyte may be present to help improving the physical and ionic contact between the electrolyte and the electrode, thus reducing the interfacial resistance. Examples of QSSEs are disclosed in the following: Hui He, et al. “Lithium Secondary Batteries Containing a Non-flammable Quasi-solid Electrolyte,” U.S. patent application Ser. No. 13/986,814 (Jun. 10, 2013); U.S. Pat. No. 9,368,831 (Jun. 14, 2016); U.S. Pat. No. 9,601,803 (Mar. 21, 2017); U.S. Pat. No. 9,601,805 (Mar. 21, 2017); U.S. Pat. No. 9,059,481 (Jun. 16, 2015).

Hence, a general object of the present invention is to provide a safe, flame/fire-resistant, quasi-solid or solid-state electrolyte system for a rechargeable lithium battery module or pack. Safe unit cells are internally connected in series to form a module and multiple modules are internally connected in parallel to form a pack. This electrode-to-module or electrode-to-pack strategy eliminates the need to make multiple cells first that are then externally connected to form a higher voltage module or pack using excessive amounts of connectors, welds, casings, etc.

### SUMMARY

The present disclosure provides a lithium battery pack, comprising one or more than one battery module wherein the module comprises a plurality of unit cells that are internally connected in series, wherein:
A) each unit cell comprises a positive electrode (PE), a negative electrode (NE), an ion-conducting separator layer (SL) disposed between the positive electrode and the negative electrode;
B) the positive electrode (cathode) comprises (i) a cathode current collector (CCC) comprising a first conductive material foil having a thickness from 10 nm to 100 μm and two opposing primary surfaces, herein referred to as a first primary surface and a second primary surface, respectively; and (ii) a positive electrode (cathode) active layer (CAL) deposited on the first primary surface and in physical or ionic contact with the separator, wherein the positive electrode layer comprises a mixture of particles of a cathode active material, a conductive additive, an optional binder resin, and a first polymer electrolyte having a lithium salt dispersed therein, which is a solid polymer electrolyte or gel polymer electrolyte, having a lithium ion conductivity no less than 1.0×10⁻⁸ S/cm at room temperature (preferably from 1.0×10⁻⁶ S/cm to 5.0×10⁻² S/cm);
C) the negative electrode (anode) comprises (iii) an anode current collector (ACC) comprising a second conductive material foil having a thickness from 10 nm to 100 μm and two opposing primary surfaces, herein referred to as a third primary surface and a fourth primary surface, respectively; and (iv) an optional negative electrode or anode active layer (AAL), deposited on the third primary surface and in physical or ionic contact with the separator, comprising a lithium metal layer or a layer of a mixture of particles of an anode active material, an optional conductive additive, an optional binder resin, a second polymer electrolyte having a lithium salt dispersed therein, which is different than or the same as the first polymer electrolyte and is a solid polymer electrolyte or gel polymer electrolyte having a lithium ion conductivity no less than 1.0×10⁻⁸ S/cm at room temperature (preferably from 1.0×10⁻⁶ S/cm to 5.0×10⁻² S/cm); and
D) an optional protective housing member that encloses the one or more than one module.
   In certain embodiments, there can be no negative electrode active layer when the battery is made; this is the so-called “anodeless” lithium battery. During the first charge procedure, lithium ions will migrate from the cathode side and deposit on a primary surface of the anode current collector.

The notion that the module comprises a plurality of unit cells that are internally connected in series implies that there are substantially free from any connectors or connecting wires between unit cells. The lithium battery pack may comprise multiple modules that are internally connected in parallel to form the pack. Preferably, a protective housing member is then implemented to enclose the pack therein. Preferably, there are essentially only two connector terminals sticking out of the protective housing.

In this disclosed battery module or pack, individual lithium-ion cells are not packaged separately in aluminum housings (or stainless steel cylindrical housings), but only the finished multi-cell battery module or pack is given a fixed housing. This significantly reduces or eliminates the need for housing components and connecting cables, thereby saving costs and space in an electric vehicle. The reduced amount of connecting wires or cables results in a lower internal resistance and higher power. The space freed up can be filled with more active material. This allows the battery to store more energy and increases the vehicle's range. This is an attractive feature of the presently disclosed battery packs. A stringent condition for such a module/pack configuration to work is having an electrolyte not being allowed to migrate from one battery cell to another, causing an internal “ionic shorting”. This condition has essentially eliminated the use of a liquid electrolyte.

Preferably, the positive electrode layer, the negative electrode layer, and/or the ion-conductive separator layer comprises particles of an inorganic solid-state electrolyte and/or particles of a ceramic or glass material. The inorganic solid electrolyte may be selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof and wherein the particles of ceramic or glass material is selected from SiO₂, TiO₂, Al₂O₃, MgO₂, ZnO₂, ZnO₂, CuO, CdO, Li₂CO₃, Li₂O, Li₂C₂O₄, LiGH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

The first or second polymer electrolyte may comprise a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trinethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

The ion-conducting separator layer may be selected from a porous polymer membrane, a nonwoven fabric, a polymer electrolyte, an inorganic solid-state electrolyte, a polymer composite electrolyte comprising particles of an inorganic solid-state electrolyte dispersed in a polymer matrix, or a polymer composite electrolyte comprising particles of a ceramic or glass material dispersed in a polymer matrix. The particles of ceramic or glass material is preferably selected from SiO₂, TiO₂, Al₂O₃, MgO₂, ZnO₂, ZnO₂, CuO, CdO, Li₂CO₃, Li₂O, Li₂C₂O₄, LiGH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

The gel polymer electrolyte contains some liquid solvent dispersed and retained in a polymer. The liquid solvent content is preferably from 1% to 30% by weight based on the combined liquid solvent/polymer weight, to the extent that the liquid solvent in the gel polymer is substantially non-flowable, exhibiting a semi-solid or solid-like behavior. This thick gel polymer electrolyte is herein referred to as a quasi-solid electrolyte.

The first or second polymer electrolyte may comprise a liquid solvent being held by or dispersed in the first or second polymer and wherein the liquid solvent is selected from the group consisting of 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, dimethyl carbonate (DMC), methylethyl carbonate (MEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, ionic liquids, and combinations thereof. (The liquid solvent-to-polymer weight ratio is preferably from 1/100 to 30/100 in the first polymer electrolyte or second polymer electrolyte.)

The positive electrode layer, the negative electrode layer, and/or the ion-conductive separator layer preferably comprises a flame retardant selected from an organic phosphorus compound, an inorganic phosphorus compound, a halogenated derivative thereof, or a combination thereof. The organic phosphorus compound or the inorganic phosphorus compound may be selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

In some preferred embodiments, the first or second solid polymer or gel polymer electrolyte and the inorganic solid-state electrolyte, in combination, form a contiguous phase in the positive electrode, the negative electrode, or both the negative and positive electrodes, and the contiguous phase is in a physical contact or ionic communication with the ion-conducting separator layer.

The disclosed battery pack may be produced by stacking the constituents in one of at least three different sequences:
1) Layer-by-layer sequence: [ACC-AAL-SL-CAL-CCC]ₘ, (integer m>2); individual layers are stacked layer by layer;
2) Electrode-separator-electrode sequence: [NE-SL-PE]ₘ, (integer m>2); in this sequence, multiple NEs, SL layers, and PEs are prepared first, followed by stacking;
3) Cell-by-cell sequence: [Unit cell]ₘ, (integer m>2) or Unit cell #1—Unit cell #2—Unit cell #3 (Unit cell 1, connected to unit cell 2, connected to unit cell 3, etc. in sequence); individual unit cells are produced first, followed by stacking cell by cell;
   wherein NE=negative electrode (anode), ACC=anode current collector, AAL=anode active layer, SL=separator layer, PE=positive electrode (cathode), CAL=cathode active layer, CCC=cathode current collector, as illustrated in FIG. 1(C).

In certain embodiments, the present disclosure provides a method of producing the aforementioned battery pack, the method comprising:
a) Providing a first set of multiple positive electrodes (cathodes), multiple negative electrodes (anodes), and multiple ion-conducting separator layers, wherein the positive electrode comprises (i) a cathode current collector (CCC) comprising a first conductive material foil having a thickness from 10 nm to 100 μm and two opposing primary surfaces, herein referred to as a first primary surface and a second primary surface, respectively; and (ii) a cathode active layer (CAL) deposited on the first primary surface and in physical or ionic contact with the separator, wherein the cathode active layer comprises a mixture of particles of a cathode active material, a conductive additive, an optional binder resin, and a first polymer electrolyte having a lithium salt dispersed therein, which is a solid polymer electrolyte or gel polymer electrolyte, having a lithium ion conductivity no less than 1.0×10⁻⁸ S/cm at room temperature (preferably from 1.0×10⁻⁶ S/cm to 5.0×10⁻² S/cm); and wherein the negative electrode comprises (iii) an anode current collector (ACC) comprising a second conductive material foil having a thickness from 10 nm to 100 μm and two opposing primary surfaces, herein referred to as a third primary surface and a fourth primary surface, respectively; and (iv) an optional anode active layer (AAL), deposited on the third primary surface and in physical or ionic contact with the separator, the negative electrode layer (if present) comprising a lithium metal layer or a layer of a mixture of particles of an anode active material, an optional conductive additive, an optional binder resin, a second polymer electrolyte having a lithium salt dispersed therein, which is different than or the same as the first polymer electrolyte and is a solid polymer electrolyte or gel polymer electrolyte having a lithium ion conductivity no less than 1.0×10⁻⁸ S/cm at room temperature (preferably from 1.0×10⁻⁶ S/cm to 5.0×10⁻² S/cm);
b) stacking the multiple positive electrodes (PE), multiple negative electrodes (NE), and multiple ion-conducting separator layers (SL) according to the sequence of [PE-SL-NE]ₘ, where m is an integer equal to or greater than 2, wherein a separator layer is disposed between, and in ionic communication with, a negative electrode layer and a positive electrode layer and wherein a cathode current collector is in a physical and electronic contact with a neighboring negative current collector;
c) applying a pressure, heat, or both pressure and heat to the stack for a desired period of time to consolidate the stack for forming a battery module; and
d) optionally encasing the module with a protective housing member to form a pack.
   In some embodiments, step b) and step c) are repeated to form at least another module in a similar manner and the resulting multiple modules are internally connected in parallel to form a pack, and step d) comprises encasing the parallel-connected multiple modules with a protective housing member to form a encased pack.

Preferably, the pressure in step c) is from 0.1 to 1,000 psi, the temperature is from 25° C. to 400° C., and the period of time is from 10 seconds to 5 hours.

In certain embodiments, the method comprises either (i) stacking PE, SL, and NE electrodes into multiple unit cells which are then stacked and internally connected in series in a unit cell-by-unit cell manner or (ii) stacking individual PE, SL, and NE electrodes in an electrode-by-electrode or layer-by-layer manner to form a module comprising internally connected unit cells.

In some embodiments, the cathode active layer (positive electrode layer) in step a) is produced by (i) mixing, dispersing, or dissolving particles of a cathode active material, optional particles of a solid inorganic solid-state electrolyte, an optional resin binder, a conductive additive, a lithium salt, and a first electrolyte polymer in a first liquid solvent to form a liquid slurry, wherein the first electrolyte polymer has a lithium-ion conductivity no less than 10⁻⁸ S/cm; (ii) depositing a layer of slurry on the first primary surface of the current collector; and (iii) partially or completely removing the first liquid solvent from the slurry layer to obtain the positive electrode layer.

In some alternative embodiments, the cathode active layer in step a) is produced by (i) mixing and dispersing particles of a cathode active material, optional particles of a solid inorganic solid-state electrolyte, an optional resin binder, and a conductive additive in a liquid medium to form a liquid slurry; (ii) depositing a layer of slurry on the first primary surface of the current collector; (iii) removing the liquid medium from the slurry layer to obtain a porous positive electrode layer containing from 1% to 50% by volume of pores; (iv) preparing a first polymer solution comprising a first polymer and a lithium salt dissolved in a first liquid solvent having a polymer-to-lithium salt weight ratio of from 1/100 to 100/1, wherein the polymer has a lithium-ion conductivity no less than 10⁻⁸ S/cm; and (v) impregnating the first polymer solution into pores of the porous positive electrode layers and partially or totally removing the first liquid solvent from the positive electrode layer to obtain the electrode.

In some embodiments, the anode active layer (negative electrode layer) in step (a) is produced by (i) mixing, dispersing, or dissolving particles of an anode active material, optional particles of a solid inorganic solid-state electrolyte, an optional resin binder, an optional conductive additive, a lithium salt, and a second electrolyte polymer in a second liquid solvent to form a liquid slurry, wherein the second electrolyte polymer has a lithium-ion conductivity no less than 10⁻⁸ S/cm; (ii) depositing a layer of slurry on the second primary surface of the current collector; and (iii) partially or completely removing the second liquid solvent from the slurry layer to obtain the negative electrode layer.

In certain embodiments, the anode active layer in step (a) is produced by (i) mixing and dispersing particles of an anode active material, optional particles of a solid inorganic solid-state electrolyte, a resin binder, and an optional conductive additive in a liquid medium to form a liquid slurry; (ii) depositing a layer of slurry on the second primary surface of the current collector; (iii) removing the liquid medium from the slurry layer to obtain a porous negative electrode layer containing from 1% to 50% by volume of pores; (iv) preparing a second polymer solution comprising a second polymer and a lithium salt dissolved in a second liquid solvent having a polymer-to-lithium salt weight ratio of from 1/100 to 100/1, wherein the second polymer has a lithium-ion conductivity no less than 10⁻⁸ S/cm; and (v) impregnating the second polymer solution into pores of the porous negative electrode layers and partially or totally removing the second liquid solvent from the positive electrode layer to obtain the electrode.

The ion-permeable separator layer may be selected from a porous polymer membrane, a nonwoven fabric, a polymer electrolyte, an inorganic solid-state electrolyte, a polymer composite electrolyte produced by dispersing particles of an inorganic solid-state electrolyte dispersed in a polymer matrix, or by dispersing particles of a ceramic or glass material dispersed in a polymer matrix. The particles of ceramic or glass material is preferably selected from SiO₂, TiO₂, Al₂O₃, MgO₂, ZnO₂, ZnO₂, CuO, CdO, Li₂CO₃, Li₂O, Li₂C₂O₄, LiGH, LiX, ROCO₂Li, HCOLi, ROLi, (ROCO₂Li)₂, (CH₂OCO₂Li)₂, Li₂S, Li_{X}SO_{y}, or a combination thereof, wherein X=F, Cl, I, or Br, R=a hydrocarbon group, x=0-1, y=1-4.

In some alternative embodiments, the cathode active layer in step a) is produced by (i) depositing a reactive cathode layer onto the first primary surface of the current collector to form a reactive cathode layer-coated current collector, wherein the reactive cathode layer comprises a mixture of multiple particles of a cathode active material, a conductive additive, and a reactive liquid electrolyte composition comprising at least a polymerizable first liquid solvent, a lithium salt dissolved in the first liquid solvent, and a crosslinking agent and/or an initiator, wherein the first liquid solvent occupies from 1% to 99% by weight based on the total weight of the reactive liquid electrolyte composition; and (ii) partially or totally polymerizing the first liquid solvent to obtain a positive electrode layer coated on the current collector wherein from 30% to 100% by weight of the polymerizable first liquid solvent is polymerized to become a quasi-solid or solid-state electrolyte that chemically bonds the multiple particles of the cathode active material and the conductive additive together to form a positive electrode layer that adheres to the first primary surface.

In some embodiments, the anode active layer in step a) is produced by (i) depositing a reactive anode layer onto a second primary surface of the current collector to form a reactive anode layer-coated current collector, wherein the reactive anode layer comprises a mixture of multiple particles of an anode active material, an optional conductive additive, and a reactive liquid electrolyte composition comprising at least a polymerizable first liquid solvent, a lithium salt dissolved in the first liquid solvent, and a crosslinking agent and/or an initiator, wherein the first liquid solvent occupies from 1% to 99% by weight based on the total weight of the reactive liquid electrolyte composition; and (ii) partially or totally polymerizing the first liquid solvent to obtain an anode active layer coated on the current collector wherein from 30% to 100% by weight of the polymerizable first liquid solvent is polymerized to become a quasi-solid or solid-state electrolyte that chemically bonds the multiple particles of the anode active material and the conductive additive together to form an anode active layer that adheres to the second primary surface.

The first polymerizable liquid solvent may be selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

The first liquid solvent may be selected from the group consisting of 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, dimethyl carbonate (DMC), methylethyl carbonate (MEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

The disclosed method enables the production of lithium battery modules and packs wherein the solid polymer or gel polymer electrolyte and the inorganic solid-state electrolyte, in combination, form a contiguous phase in the cathode, in the anode, or in both the anode and the cathode, and the contiguous phase is in a physical contact or ionic communication with the ion-conducting separator or solid-state electrolyte layer.

In certain embodiments, one or both of the primary surfaces of the conductive material foil (e.g., Al foil, Cu foil, stainless steel cell, etc.) is coated with a layer of graphene or expanded graphite sheets having a layer thickness from 1 nm to 50 μm. This could prevent lithium diffusion in the metal foil, which otherwise could degrade the function of a electrode

Alternatively, this conductive foil contains a laminate of two or more conductive materials laminated together. For instance, this can contain a layer of Cu (for supporting the negative electrode layer) and a layer of Al (for supporting the positive electrode layer) that are mechanically compressed or chemically bonded together. This can also be a Cu foil or Al foil coated with a layer of conductive polymer (e.g., an intrinsically conductive polymer or a polymer matrix containing conductive fillers dispersed therein; examples of conductive fillers being graphene sheets, carbon nanotubes, carbon fibers, carbon black particles, etc.).

The positive electrode layer or the negative electrode layer may further comprise a second liquid solvent and the first liquid solvent has a lower flash point, a higher vapor pressure, a higher dielectric constant, or a higher solubility of the lithium salt as compared with the second liquid solvent.

Preferably, the first liquid solvent or the second liquid solvent comprises a flame retardant selected from an organic phosphorus compound, an inorganic phosphorus compound, a halogenated derivative thereof, or a combination thereof. The organic phosphorus compound or the inorganic phosphorus compound is selected from the group consisting of phosphates, phosphonates, phosphonic acids, phosphorous acids, phosphites, phosphoric acids, pbosphinates, phosphines, phosphine oxides, phosphazene compounds, derivatives thereof, and combinations thereof.

In some embodiments, the negative electrode layer comprises a lithium metal layer. This lithium metal layer may comprise a lithium foil, lithium particles, protected lithium particles, etc. This lithium metal layer may be absent when the electrode or the resultant bi-polar lithium battery is made and prior to the first battery charge. After the battery is charged, the primary surface at the anode side is deposited with a layer of lithium metal whose constituent lithium metal members come from the cathode side.

In some embodiments, the second liquid solvent (the same as or different than the first liquid solvent) is selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphiies, plosphine oxides, phosphonic acids, phosphorous acid, phosphites, phosphoric acids, phosphazene compounds, derivatives thereof, and combinations thereof, Some of these solvents (e.g., vinylene carbonate, ethylene carbonate) tend to have a relatively low flash points, high flammability, but good ability to dissolve a lithium salt.

In the conventional lithium-ion battery or lithium metal battery, the liquid solvents listed above are commonly used as a solvent to dissolve a lithium salt therein and the resulting solutions are used as a liquid electrolyte. These liquid solvents have a relatively high dielectric constant and, hence, are capable of dissolving a high amount of a lithium salt. These liquid solvents can be used to dissolve both a lithium salt and a polymer having an ion conductivity greater than 10⁻⁸ S/cm to form a polymer solution. The polymer solution may be impregnated into pores of a dry cathode (positive electrode) or anode (negative electrode) making contact with the cathode or the anode active material and with particles of an inorganic solid electrolyte. By removing the liquid solvent, one obtains a polymer electrolyte (along with an inorganic electrolyte to form a hybrid electrolyte or composite electrolyte).

Alternatively, one can polymerize the liquid solvent once the liquid electrolyte (having a lithium salt dissolved in the first liquid solvent) is mixed into an electrode (an anode active layer or a cathode active layer, for instance). With such a novel strategy, one can readily reduce the liquid solvent or completely eliminate the volatile liquid solvent all together. A desired amount of a second liquid solvent, preferably a flame-resistant liquid solvent, may be retained in the battery cell to improve the lithium ion conductivity of the electrolyte, if so desired. This strategy enables us to achieve several desirable attributes of the resultant electrolyte: no liquid electrolyte leakage issue (the in situ cured polymer being capable of holding the remaining liquid together to form a gel), adequate lithium salt amount, good lithium ion conductivity, reduced or eliminated flammability, good ability of the electrolyte to wet on anode/cathode active material surfaces (hence, significantly reduced interfacial impedance and internal resistance), processing ease, compatibility with current lithium-ion battery production processes and equipment, etc. This is of significant utility value since most of the organic solvents are known to be volatile and flammable, posing a fire and explosion danger and current solid-state electrolytes are not compatible with existing lithium-ion battery manufacturing equipment and processes. In the present electrode-based lithium battery, the electrolyte will not migrate from one unit cell to another; this is a necessary condition for a battery.

In certain embodiments, the first or the second liquid solvent is selected from the group consisting of fluorinated ethers, fluorinated esters, sulfones, sulfides, nitriles, sulfates, siloxanes, silanes, combinations thereof, and combinations with phosphates, phosphonates, phosphinates, phosphines, phosphine oxides, phosphonic acids, phosphorous acid, phosphites, phosphoric acids, phosphazene compounds, derivatives thereof, and combinations thereof.

Preferably, the lithium salt occupies 0.1%-50% by weight and the crosslinking agent and/or initiator occupies 0.1-50% by weight of the reactive additive.

In certain embodiments, the reactive additive (e.g., for the production of the negative electrode layer) comprises a polymerizable first liquid solvent and a second liquid solvent and wherein the second liquid solvent either is not polymerizable or is polymerizable but polymerized to a lesser extent as compared to the first liquid solvent. The presence of this second liquid solvent is designed to impart certain desired properties to the polymerized electrolyte, such as lithium ion conductivity, flame retardancy, and the ability of the electrolyte to permeate into the electrode (anode and/or cathode) to properly wet the surfaces of the anode active material and/or the cathode active material.

The first or the second liquid solvents may include fluorinated monomers having unsaturation (double bonds or triple bonds that can be opened up for polymerization); e.g., fluorinated vinyl carbonates, fluorinated vinyl monomers, fluorinated esters, fluorinated vinyl esters, and fluorinated vinyl ethers). Fluorinated vinyl esters include R_{f}CO₂CH═CH₂ and Propenyl Ketones, R_{f}COCH═CHCH₃, where R_{f} is F or any F-containing functional group (e.g., CF₂— and CF₂CF₃—).

Desirable sulfones as a first or second liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone:

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R=NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

Poly(sulfone)s have high oxygen indices and low smoke emission on burning. Poly(sulfone)s are inherently self-extinguishing materials owing to their highly aromatic character. In certain embodiments, the sulfone as a first or the second liquid solvent is selected from TrMS, MTrMS, TMS, or vinyl or double bond-containing variants of TrMS, MTrMS, TMS, EMS, MMES, EMES, EMEES, or a combination thereof. The cyclic structure, such as TrMS, MTrMS, and TMS, can be polymerized via ring-opening polymerization with the assistance of an ionic type initiator.

The first or the second liquid solvent may be a nitrile preferably selected from dinitriles, such as AND, GLN, SEN and SN.

In some embodiments, the phosphate, phosphonate, phosphazene, phosphite, or sulfate, as a first liquid solvent or in the second liquid solvent, is selected from tris(trimethylsilyl) phosphite (TTSPi), alkyl phosphate, triallyl phosphate (TAP), ethylene sulfate (DTD), a combination thereof.

The phosphate, alkyl phosphonate, phosphonic acid, and phosphazene are flame-resistant. Good examples include diethyl vinylphosphonate, dimethyl vinylphosphonate, vinylphosphonic acid, diethyl allyl phosphate, and diethyl allylphosphonate:

The siloxane or silane in the second liquid solvent may be selected from alkylsiloxane (Si—O), alkyylsilane (Si—C), liquid oligomeric silaxane (—Si—O—Si—), or a combination thereof.

The reactive additive may further comprise an amide group selected from N,N-dimethylacetanide, N,N-diethylacetarmide, N,N-dimethylformarmide, N,N-diethylforimamide, or a combination thereof.

In certain embodiments, the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule. In certain embodiments, the crosslinking agent is selected from poly(diethanol) diacrylate, poly(ethylricglycol)dimethacrylate, poly(diethanol) dimethylacrylate, poly(ethylene glycol) diacrylate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a cormbination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, or a combination thereof.

In the disclosed polymer electrolyte, the lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The positive electrode (cathode) in the disclosed lithium cell typically comprises particles of a cathode active material and the electrolyte permeates into the cathode to come in physical contact with substantially all the cathode active material particles.

In some preferred embodiments, the battery cell contains substantially no liquid solvent left therein (substantially>99% of the liquid solvent being removed or polymerized to become a polymer). However, it is essential to initially include a liquid solvent in the cell, enabling the lithium salt to get dissociated into lithium ions and anions. A majority (>50%, preferably >70%) or substantially all of the liquid solvents is then vaporized or cured (polymerized or crosslinked). With less than 1% liquid solvent, the resulting electrolyte is a solid-state electrolyte. With less than 30% liquid solvent, we have a quasi-solid electrolyte. Both are highly flame-resistant.

A lower proportion of the liquid solvent in the electrolyte leads to a significantly reduced vapor pressure and increased flash point or completely eliminated flash point (un-detectable). Although typically by reducing the liquid solvent proportion one tends to observe a reduced lithium ion conductivity for the resulting electrolyte; however, quite surprisingly, after a threshold liquid solvent fraction, this trend is diminished or reversed (the lithium ion conductivity can actually increase with reduced liquid solvent in some cases).

The crosslinking agent preferably comprises a compound having at least one reactive group selected from a hydroxyl group, an amino group, an imino group, an amide group, an amine group, an acrylic group, or a mercapto group in the molecule.

In some embodiments, the crosslinking agent may be selected from N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid, acrylic acid, methacrylic acid, a derivative compound of acrylic acid, a derivative compound of methacrylic acid, glycidyl functions, N,N′-Methylenebisacrylarmide (MBAAm), Ethylene glycol dimethacrylate (EGDMAAm), isobornyl methacrylate, poly(acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate, an urethane chain, a chemical derivative thereof, or a combination thereof.

In certain desirable embodiments, in both the positive and the negative electrodes, the electrolyte further comprises particles of an inorganic solid electrolyte material having a particle size from 2 nm to 30 μm, wherein the particles of inorganic solid electrolyte material are dispersed in the polymer or chemically bonded by the polymer. The particles of inorganic solid electrolyte material are preferably selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

Preferably, in the lithium battery, the separator comprises a quasi-solid or solid-state electrolyte.

The lithium battery may be a lithium metal secondary battery (initially having a lithium metal layer or without a lithium metal layer when the battery is made), a lithium-ion battery, a lithium-sulfur battery, a lithium-ion sulfur battery, a lithium-selenium battery, or a lithium-air battery. A preferred embodiment of the present invention is a rechargeable lithium-sulfur battery or lithium-ion sulfur battery containing a sulfur cathode having sulfur or lithium polysulfide as a cathode active material.

The liquid solvent (containing a polymer dissolved therein) or the reactive electrolyte composition (reactive additive) is designed to permeate into the internal structure of the cathode and to be in physical contact or ionic contact with the cathode active material in the cathode, and to permeate into the anode electrode to be in physical contact or ionic contact with the anode active material where/if present.

For a lithium metal battery (wherein lithium metal is the primary active anode material), the current collector may comprise a metal foil (e.g., Al foil, Cu foal, stainless steel cell) having two primary surfaces wherein at least one primary surface is coated with a layer of graphene, or expanded graphite. One coated primary surface (the anode side) may be further coated with or protected by a layer of lithiophilic metal (a metal capable of forming a metal-Li solid solution or is wettable by lithium ions), a layer of graphene material, or both. The lithiophilic metal is preferably selected from Au, Ag, Mg, Zn, Ti, K, Al, Fe, Mn, Co, Ni, Sn, V, Cr, an alloy thereof, or a combination thereof.

For a lithium ion battery pack, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other members; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

In some embodiments, the anode active material contains a prelithiated Si, prelithiated Ge, prelithiated Sn, prelithiated SnOx, prelithiated SiOx, prelithiated iron oxide, prelithiated V₂O₅, prelithiated V₃O₈, prelithiated Co₃O₄, prelithiated Ni₃O₄, or a combination thereof, wherein x=1 to 2.

The separator may comprise a polymer, inorganic, or composite solid electrolyte; it may simply comprise a porous polymer membrane. In certain embodiments, the separator comprises polymeric fibers, ceramic fibers, glass fibers, or a combination thereof. These fibers may be stacked together in such a manner that there are pores that allow for permeation of lithium ions, but not for penetration of any potentially formed lithium dendrites. These fibers may be dispersed in a matrix material or bonded by a binder material. This matrix or binder material may contain a ceramic or glass material. The polymer electrolyte herein disclosed may serve as the matrix material or binder material that helps to hold these fibers together. The separator may contain particles of a glass or ceramic material (e.g., metal oxide, metal carbide, metal nitride, metal boride, etc.).

In summary, the disclosure also provides a method of producing a battery pack, the method comprising (a) preparing multiple positive electrodes each comprising a cathode active layer supported by a cathode current collector, multiple ion-conducting separators, and multiple negative electrodes each comprising an optional anode active layer supported by an anode current collector, wherein at least one of the cathode active layer, the anode active layer, and the separator comprises a polymer electrolyte or a polymer composite electrolyte; (b) stacking the positive electrodes, separators and negative electrodes sequentially to form a battery stack comprising multiple unit cells internally connected in series; (c) exerting a pressure along a stacking direction or a pressure and heat to the battery stack to form a module; and (d) optionally encasing the module with a protective housing member to form a pack.

Step (a), step (b) and step (c) may be repeated to form multiple modules and the method further comprises internally connecting the resulting multiple modules in parallel, and step (d) comprises encasing the parallel-connected multiple modules with a protective housing member to form a pack.

The disclosure further discloses a method of producing a battery pack, wherein the method comprises stacking pack components in at least one of the following three sequences: (i) layer-by-layer, (ii) electrode-separator-electrode, and (iii) cell-by-cell sequences.

These and other advantages and features of the present invention will become more transparent with the description of the following best mode practice and illustrative examples.

### BRIEF DESCRIPTION OF THE DRAWINGS

FIG. 1(A) Schematic of conventional lithium-ion battery cells: Type-1 unit cell includes an anode current collector (52), one anode active layer (54) bonded to the anode current collector, an ion-conducting separator (56), a cathode active layer (60) bonded to a cathode current collector (58) and Type-2 unit cell includes an anode current collector (52), two anode active layers (54a, 54b) bonded to the anode current collector, an ion-conducting separator (56), two cathode active layer (60a, 60b) bonded to two primary surfaces of a cathode current collector (58);

FIG. 1(B) Schematic of a prior art lithium-ion battery module or pack, wherein multiple unit cells, each encased in a protective housing member (e.g., a stainless steel cylindrical tube), are externally connected in series with connecting wires and terminal tabs (not shown);

FIG. 1(C) Schematic of a module according to certain embodiments of the present disclosure, wherein the module is made by stacking constituents in one of the following stacking sequences: (i) Layer-by-layer sequence: [ACC-AAL-SL-CAL-CCC]ₘ, (m is an integer>1; m=3 in this example); (ii) Electrode-separator-electrode sequence: [NE-SL-PE]ₘ, (m=3 in this example); and (iii) Cell-by-cell sequence: [Unit cell]ₘ, (m=3 in this example) or Unit cell #1—Unit cell #2—Unit cell #3 (Unit cell 1, connected to unit cell 2, connected to unit cell 3, etc. in sequence). The unit cell can be Type-1 or Type-2, but Type-1 is preferred.

FIG. 2(A) Schematic of a module (super-cell) comprising multiple electrodes/separators (or multiple unit cells) that are internally connected in series with a pressure applied to the stacking direction according to some embodiments of the present disclosure;

FIG. 2(B) Schematic of a battery pack comprising a plurality of modules (each comprising internally series-connected electrodes/separators or unit cells); these modules are internally connected in parallel to form a pack according to some embodiments of the present disclosure;

FIG. 2(C) Schematic of a battery pack comprising a plurality of modules, internally connected in parallel and enclosed in a protective housing according to some embodiments of the present disclosure.

FIG. 3(A) Structure of an anode-less lithium metal battery (as manufactured or in a discharged state) according to some embodiments of the present disclosure;

FIG. 3(B) Structure of a anode-less lithium metal battery (in a charged state) according to some embodiments of the present disclosure.

FIG. 4(A) Schematic of a process for producing a positive electrode comprising a cathode active layer deposited on a primary surface of a cathode current collector according to some embodiments of instant disclosure (removal of a liquid medium to form a solid polymer electrolyte in the cathode); a negative electrode may be produced in a similar manner.

FIG. 4(B) Schematic of another process for producing a positive electrode comprising a cathode active layer deposited on a primary surface of a cathode current collector according to some embodiments of instant disclosure (filling pores in the cathode active layer with a polymer solution, followed by removing liquid electrolyte from the polymer solution); a negative electrode may be produced in a similar manner.

FIG. 4(C) Schematic of a process for producing a negative electrode comprising an anode active layer deposited on a primary surface of an anode current collector according to some embodiments of instant disclosure (polymerization and/or crosslinking of a polymerizable liquid solvent in the anode); positive electrode may be produced in a similar manner.

FIG. 5 Schematic of a process to produce a roll of electrode in a roll-to-roll or reel-to-reel manner according to some embodiments of the present disclosure.

### DETAILED DESCRIPTION

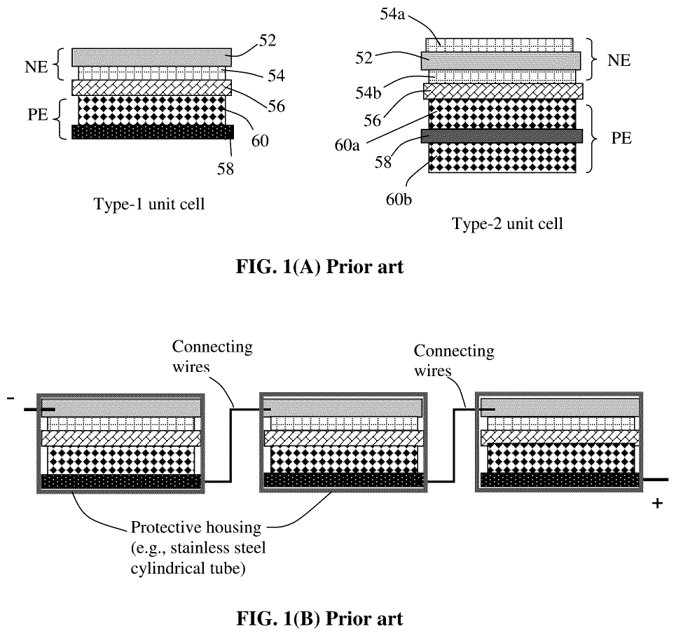

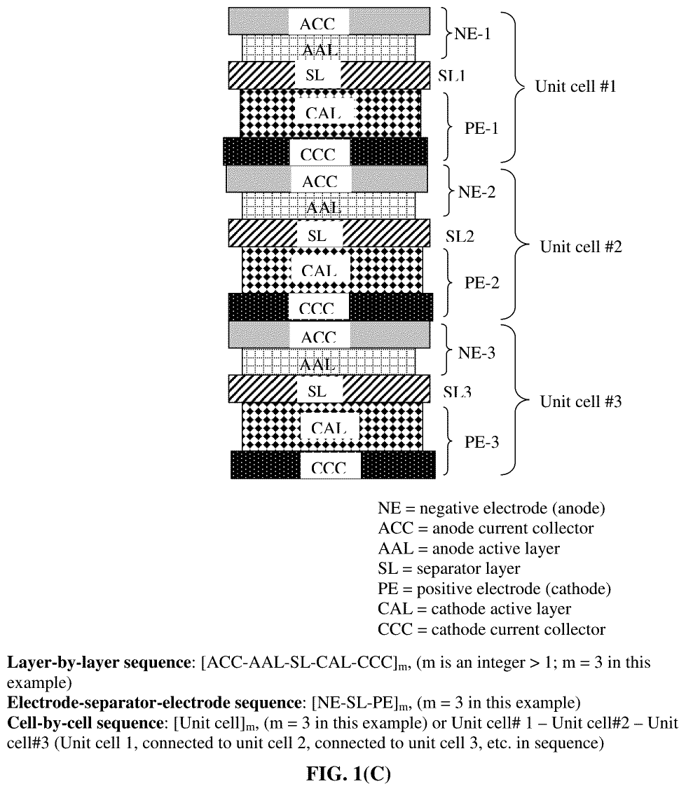

As schematically illustrated in FIG. 1(A), the conventional lithium-ion battery cells can be divided into two different types: Type-1 and Type-2 unit cells. Type-1 unit cell includes (i) a negative electrode (NE) or anode which is composed of an anode current collector (52) and one anode active layer (54) bonded to the anode current collector; (ii) an ion-conducting separator (56); and (iii) a positive electrode (PE) or cathode, which is composed of a cathode active layer (60) bonded to a cathode current collector (58). Type-2 unit cell includes (i) a negative electrode (NE), which is composed of an anode current collector (52) and two anode active layers (54a, 54b) bonded to the two primary surfaces of an anode current collector; (ii) an ion-conducting separator (56); and (iii) a positive electrode, composed of two cathode active layers (60a, 60b) bonded to the two primary surfaces of a cathode current collector (58).

As illustrated in FIG. 1(B), a prior art lithium-ion battery module or pack comprises multiple unit cells (Type-1 or Type-2), each encased in a protective housing member (e.g., a stainless steel cylindrical tube), which are externally connected in series with connecting wires and terminal tabs (not shown). For electric vehicle applications, a battery pack typically comprises hundreds of unit cells (some containing thousands of cells), implying that there are hundreds or thousands of connectors. These add significant weights, volumes, and costs to the EV battery system and reduce the energy density. In addition. The electric resistance associated with these connectors also significantly increases the resistance of the battery module or pack, thereby reducing the power density of the battery pack. It is therefore highly desirable to reduce or even eliminate the need to have these external connecting means.

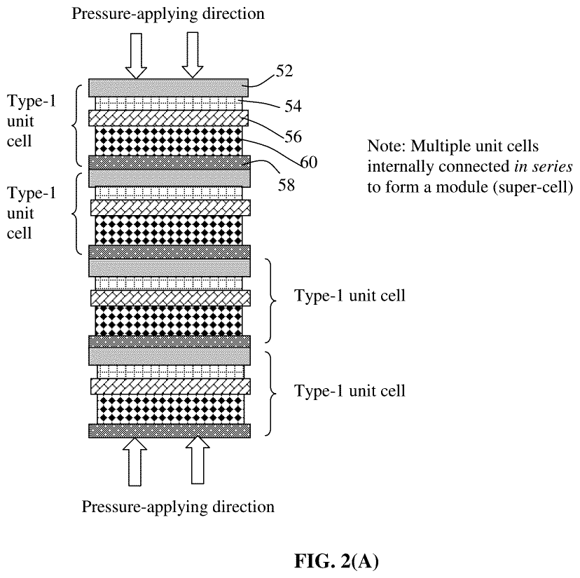

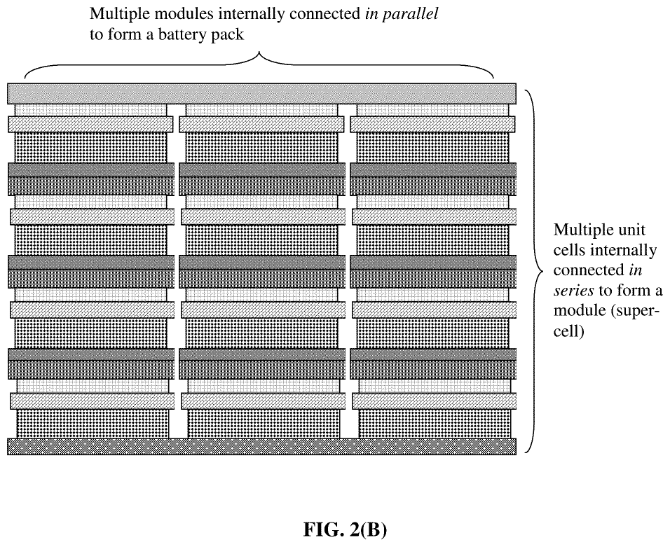

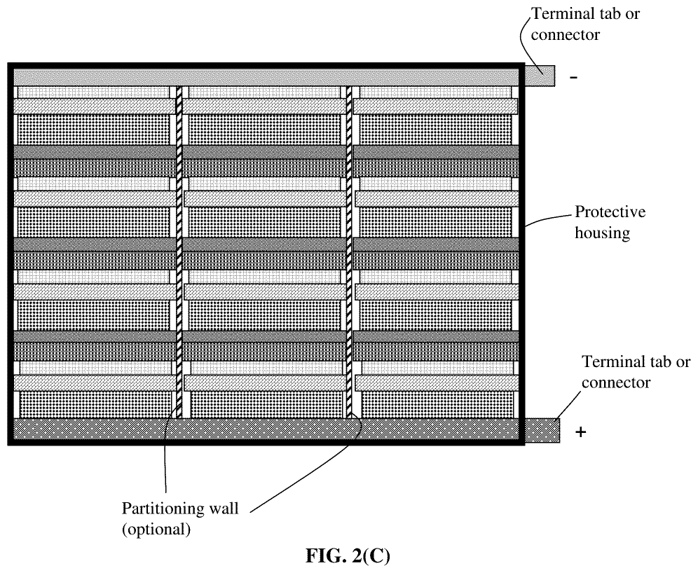

FIG. 1(C) and FIG. 2(A) schematically show a module according to certain embodiments of the present disclosure, wherein the module is made by stacking constituents in one of the following stacking sequences: (i) Layer-by-layer sequence: [ACC-AAL-SL-CAL-CCC]ₘ, (m is an integer>1; m=3 in this example); (ii) Electrode-separator-electrode sequence: [NE-SL-PE]ₘ, (m=3 in this example); and (iii) Cell-by-cell sequence: [Unit cell]ₘ, (m=3 in this example) or Unit cell #1—Unit cell #2—Unit cell #3 (Unit cell 1, connected to unit cell 2, connected to unit cell 3, etc. in sequence), wherein NE=negative electrode (anode), ACC=anode current collector, AAL=anode active layer, SL=separator layer, PE=positive electrode (cathode), CAL=cathode active layer, CCC=cathode current collector. Multiple modules of this type of internally series-connected unit cells can then be internally connected in parallel to form a battery pack, as schematically illustrated in FIG. 2(B) and FIG. 2(C). Such a battery pack structure reduces and largely eliminates the need to have external connectors between cells and those between modules.

The present invention provides a lithium battery module or pack comprising internally connected lithium battery cells, which can be any of various types of lithium-ion or lithium metal batteries. A high degree of safety is imparted to this battery by a novel and unique electrolyte that is highly flame-resistant and would not initiate a fire or sustain a fire and, hence, would not pose explosion danger. This invention has solved the very most critical issue that has plagued the lithium-metal and lithium-ion industries for more than two decades. As indicated earlier in the Background section, a strong need exists for a safe, non-flammable quasi-solid electrolyte or solid-state electrolyte system for a rechargeable lithium battery. This electrolyte strategy also enables the production of a battery module or pack in a layer-by-layer, electrode-by-electrode (or separator), or unit cell-by-unit cell manner. This approach also makes it possible to produce a pack directly from electrodes and separators without going through the cell production and module production steps.

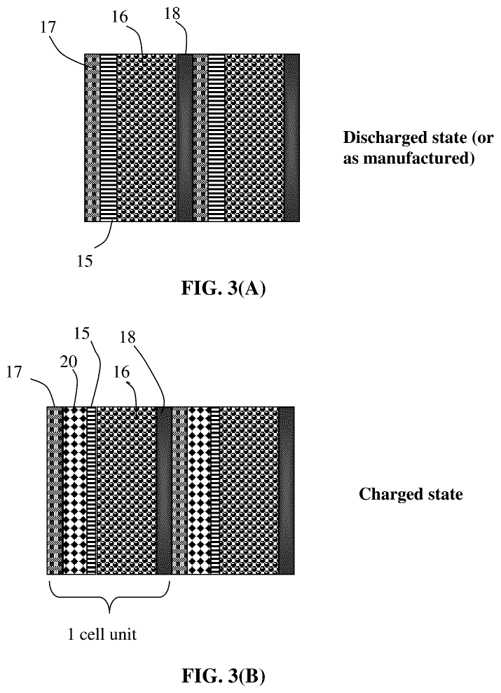

In certain embodiments, as illustrated in FIG. 2(A), 2(B) and 2(C), the present disclosure provides a lithium battery pack, comprising one or more than one battery module wherein the module comprises a plurality of unit cells that are internally connected in series, wherein:
A. each unit cell comprises a positive electrode (PE), a negative electrode (NE), an ion-conducting separator layer (SL) disposed between the positive electrode and the negative electrode;
B. the positive electrode (cathode) comprises (i) a cathode current collector (CCC) comprising a first conductive material foil having a thickness from 10 nm to 100 μm and two opposing primary surfaces, herein referred to as a first primary surface and a second primary surface, respectively; and (ii) a positive electrode (cathode) active layer (CAL) deposited on the first primary surface and in physical or ionic contact with the separator, wherein the positive electrode layer comprises a mixture of particles of a cathode active material, a conductive additive, an optional binder resin, and a first polymer electrolyte having a lithium salt dispersed therein, which is a solid polymer electrolyte or gel polymer electrolyte, having a lithium ion conductivity no less than 1.0×10⁻⁸ S/cm at room temperature (preferably from 1.0×10⁻⁶ S/cm to 5.0×10⁻² S/cm);
C. the negative electrode (anode) comprises (iii) an anode current collector (ACC) comprising a second conductive material foil having a thickness from 10 nm to 100 μm and two opposing primary surfaces, herein referred to as a third primary surface and a fourth primary surface, respectively; and (iv) an optional negative electrode or anode active layer (AAL), deposited on the third primary surface and in physical or ionic contact with the separator, comprising a lithium metal layer or a layer of a mixture of particles of an anode active material, an optional conductive additive, an optional binder resin, a second polymer electrolyte having a lithium salt dispersed therein, which is different than or the same as the first polymer electrolyte and is a solid polymer electrolyte or gel polymer electrolyte having a lithium ion conductivity no less than 1.0×10⁻⁸ S/cm at room temperature (preferably from 1.0×10⁻⁶ S/cm to 5.0×10⁻² S/cm); and
D. an optional protective housing member that encloses the one or more than one module.
   In certain embodiments, there can be no negative electrode active layer when the battery is made (as illustrated in FIG. 3(A)); this is the so-called “anodeless” lithium battery. During the first charge procedure, lithium ions will migrate from the cathode side and deposit on a primary surface of the anode current collector (FIG. 3(B)).

The notion that the module comprises a plurality of unit cells that are internally connected in series implies that the module is substantially free from any connectors or connecting wires between unit cells. The lithium battery pack may comprise multiple modules that are internally connected in parallel to form the pack. Preferably, a protective housing member is then implemented to enclose the pack therein. Preferably, there are essentially only two connector terminals sticking out of the protective housing.

In this disclosed battery module or pack, individual lithium-ion cells are not packaged separately in aluminum housings (or stainless steel hollow cylinder housings), but only the finished multi-cell battery module or pack is given a fixed housing. This significantly reduces or eliminates the need for housing components and connecting cables, thereby saving costs and space in an electric vehicle. The reduced amount of connecting wires or cables results in a lower internal resistance and higher power. The space freed up can be filled with more active material. This allows the battery to store more energy and increases the vehicle's range. This is an attractive feature of the presently disclosed battery packs. A stringent condition for such a module/pack configuration to work is having an electrolyte not being allowed to migrate from one battery cell to another, causing an internal “ionic shorting”. This condition has essentially eliminated the use of a liquid electrolyte. The present disclosure provides quasi-solid and solid-state electrolytes that meet this requirement.

Preferably, the positive electrode layer, the negative electrode layer, or the ion-conductive separator layer comprises particles of an inorganic solid-state electrolyte and/or particles of a ceramic or glass material dispersed in a polymer electrolyte matrix or bonded by a polymer. The inorganic solid electrolyte may be selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof and wherein the particles of ceramic or glass material is selected from SiO₂, TiO₂, Al₂O₃, MgO₂, ZnO₂, ZnO₂, CuO, CdO, Li₂CO₃, Li₂O, Li₂C₂O₄, LiGH, LiX, ROCO₂Li, HCOLi, ROLi, (ROCO₂Li)₂, (CH₂OCO₂Li)₂, Li₂S, Li_{X}SO_{y}, or a combination thereof, wherein X=F, Cl, I, or Br, R=a hydrocarbon group, x=0-1, y=1-4.

The first or second polymer electrolyte may comprise a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trinethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

The ion-conducting separator layer may be selected from a porous polymer membrane, a nonwoven fabric, a polymer electrolyte, an inorganic solid-state electrolyte, a polymer composite electrolyte comprising particles of an inorganic solid-state electrolyte dispersed in a polymer matrix, or a polymer composite electrolyte comprising particles of a ceramic or glass material dispersed in a polymer matrix. The particles of ceramic or glass material is preferably selected from SiO₂, TiO₂, Al₂O₃, MgO₂, ZnO₂, ZnO₂, CuO, CdO, Li₂CO₃, Li₂O, Li₂C₂O₄, LiGH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

In certain embodiments, one or both of the primary surfaces of the conductive material foil (e.g., Al foil, Cu foil, stainless steel cell, etc.) is coated with a layer of graphene or expanded graphite sheets having a layer thickness from 1 nm to 50 μm. This could prevent lithium diffusion in the metal foil, which otherwise could degrade the function of a electrode

In some preferred embodiments, the solid polymer or gel polymer electrolyte and the inorganic solid-state electrolyte, in combination, form a contiguous phase in the cathode, in the anode, or in both the anode and the cathode, and the contiguous phase is in a physical contact or ionic communication with the ion-permeable separator or solid-state electrolyte layer. This would ensure uninterrupted flow of lithium ions from the cathode, through the separator (or solid-state electrolyte), into the anode during the battery charge, as well as flow from the anode through the separator and into the cathode (throughout the entire cathode).

As illustrated in FIG. 1(C) as one example, the internal series connection (ISC) technology involves combining a desired number of positive electrodes (PE) and negative electrodes (NE), with one NE and one PE being separated from one another by an ion-conducting separator. In this configuration, only these two terminal electrodes are externally connected to the outside circuit and all the intermediate electrodes and individual unit cells are isolated from the outside circuit. Series connection provides a high voltage output (high V), which is the sum of the voltage values of all cells: for instance, if one cell giving 3.7 volts (e.g., for a graphite-LiCo₂ cell), then two cells giving 7.4 volts, and n cells giving 3.7n volts, etc. The number n can be any integer that is 2 or greater than 2 (for practical purposes, n is from 2 to 1,000). This is further illustrated in FIG. 2(A), wherein a pressure is exerted to the stack during module manufacturing.

During a charging step, lithium ions come out of the cathode active material layer (supported on a cathode current collector), and travels through a separator into an anode active material layer, which belongs to the same unit cell but supported by an anode current collector. During a subsequent discharge step, lithium ions travel in the opposite direction. These lithium ions are confined in a unit cell, and not to be allowed to stray into a neighboring cell. This condition can be met if the electrolyte is a solid-state electrolyte and the current collector is made out of an electrically conductive material that is not permeable to lithium ions. The graphene or expanded graphite (or exfoliated graphite worm) coating makes the metal foil non-permeable to lithium ions.

The number of unit cells in a stack depends upon the needed output voltage of the stack. Using a unit cell voltage of 3.7 volts as a basis, a lithium-ion battery stack for use in an electric power scooter (48V), for instance, will require 13 unit cells connected in series. Such a stack constitutes a lithium-ion battery “member” which, if inserted into a casing and fitted with a PC board (control electronics), makes a great power module.

As schematically illustrated in FIG. 2(B), multiple modules, each composed of internally series-connected plates, may be internally connected in parallel to form a battery pack to increase the battery capacity (Amp-hours, or Ah). As illustrated in FIG. 2(C), the battery pack is preferably protected by a protective housing, allowing at least two terminals protruded out of the housing unit for connecting to an outside circuit.

In a special battery configuration, a primary surface of the cathode current collector is deposited with a cathode active material layer containing particles of a cathode active material (e.g., LiCoO₂, LiMn₂O₄, etc.) having available Li atoms in the structure; but the primary surface of an anode current collector is not deposited with any anode material (as schematically illustrated in FIG. 3(A)) or is deposited with a lithium metal-protecting layer only (such as an elastic polymer or a graphene ball layer) but no lithium metal or other anode active material when the battery is made (prior to the first charge step). Such a lithium battery is herein referred to as an “anode-less” lithium metal battery. During the discharge step, lithium ions come out of the cathode material structure, traverse a separator, and move to the anode side where the lithium ions deposit onto the opposing primary surface of the current collector to form a lithium metal layer. This is illustrated in FIG. 3(B).

The presently invented internal series connection (ISC) and internal parallel connection (IPC) battery technology has the following features:

(1) The electrolyte from one unit cell is not allowed to enter another unit cell; there is no fluid communication between two cells. This is achieved by using the presently disclosed quasi-solid or solid-state electrolytes that are introduced into individual electrodes or separators, instead of injecting liquid electrolytes into dry cells after the cells are made. None of the current collectors can be porous; they have to be absolutely impermeable to electrolyte and lithium ions. This is achieved by using a solid metal foil which is preferably further protected by a graphene or expanded graphite layer.

(2) Any output voltage (V) and capacity value (Ah) can be tailor-made by selecting a proper number of unit cells and the lateral dimensions and thickness of the anode layer and the cathode layer of a unit cell; any practical voltage can be easily obtained. The capacity value of a pack can be increased by increasing the number of modules connected in parallel.

(3) During re-charge, each constituent cell in a multi-cell battery stack can adjust itself to attain voltage distribution equilibrium, removing the need for the high-voltage stack to have a protective circuit.

(4) The ISC and IPC technology enables significant savings in materials, volume and weight of cell-to-cell connectors and elimination of most welds necessary for the conventional modules/packs.

(5) As such, much higher energy density, higher specific energy, and higher power density can be achieved at lower costs.

(6) With multiple cells electrically connected in series naturally, one can produce a high-voltage “super-cell” having an output voltage from 6.4 volts to 800+ volts (no theoretical upper limit) with minimal connector weights, volumes, and costs.

In the conventional lithium-ion battery or lithium metal battery industry, the liquid solvents are commonly used as a solvent to dissolve a lithium salt therein and the resulting solutions are used as a liquid electrolyte. These liquid solvents have a relatively high dielectric constant and, hence, are capable of dissolving a high amount of a lithium salt. However, they are typically highly volatile, having a low flash point and being highly flammable.

In the presently disclosed electrodes, the cathode (positive electrode) active layer and the anode (negative electrode) active layer contain substantially solid-state electrolytes produced by at least two approaches: (1) dissolving a polymer and a lithium salt in a liquid medium to obtain a liquid solution, allowing the liquid solution to permeate into an active material electrode and well mix with other solid ingredients (e.g., particles of an active material, conductive additive, binder, and particles of an inorganic solid electrolyte) in an active material electrode, followed by removing the liquid medium, resulting in the formation of a solid-state electrolyte (e.g., polymer alone or polymer/inorganic composite solid electrolyte); and (2) dissolving a monomer or oligomer, an initiator and/or crosslinking agent, and a lithium salt in a liquid solvent (the monomer itself may be the liquid solvent) to obtain a liquid solution, allowing the liquid solution to permeate into an active material electrode and well mix with other solid ingredients (e.g., particles of an active material, conductive additive, binder, and particles of an inorganic solid electrolyte) in an active material electrode, followed by polymerizing/crosslinking the polymerizable liquid solvent or monomer, resulting in the formation of a solid-state electrolyte.

It is highly advantageous to be able to polymerize the liquid solvent once the liquid electrolyte (having a lithium salt dissolved in the first liquid solvent) is mixed with particles of an electrode active material (cathode active material or anode active material) or injected into an electrode (cathode layer or anode layer). With such an innovative strategy, one can readily reduce the liquid solvent (leaving behind select non-flammable or flame-retardant solvent only, if so desired) or completely eliminate the volatile liquid solvent all together. A desired amount of a second liquid solvent, preferably a flame-resistant liquid solvent, may be retained in the battery cell (forming a gel polymer electrolyte or quasi-solid electrolyte) to improve the lithium-ion conductivity of the electrolyte. Desirable flame retardant-type second liquid solvents are, as examples, alkyl phosphates, alkyl phosphonates, phosphazenes, hydrofluoroethers, fluorinated ethers, and fluorinated esters.

This strategy enables us to achieve several desirable features of the resultant electrolytes and batteries:
a) no liquid electrolyte leakage issue (the in situ cured polymer or solidified polymer being capable of holding the remaining liquid together to form a gel or quasi-solid);
b) adequate lithium salt amount can be dissolved in the electrolyte, enabling a good lithium ion conductivity;
c) reduced or eliminated flammability (only a solid polymer/inorganic solid electrolyte and, if desired, a non-flammable second liquid are retained in the cell);
d) good ability of the electrolyte to wet on anode/cathode active material surfaces (hence, significantly reduced interfacial impedance and internal resistance);
e) processing ease and compatibility with current lithium-ion battery production processes and equipment, etc.; and
f) enabling a high cathode active material proportion in the cathode electrode (typically 75-97%, in contrast to typically less than 75% by weight of the cathode active material when working with a conventional solid polymer electrolyte or inorganic solid electrolyte.
   This disclosed in situ-cured polymer and/or in situ-solidified (solvent removal) electrolyte approach is of significant utility value since most of the organic solvents are known to be volatile and flammable, posing a fire and explosion danger. Further, current solid-state electrolytes are not compatible with existing lithium-ion battery manufacturing equipment and processes.

In certain preferred embodiments, the first or the second liquid solvent comprises a flame-resisting or flame-retardant liquid selected from an organic phosphorus compound, an inorganic phosphorus compound, a halogenated derivative thereof, or a combination thereof. The organic phosphorus compound or the inorganic phosphorus compound preferably is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

In certain embodiments, the first or the second liquid solvent is selected from the group consisting of fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

In some embodiments, the second liquid solvent is selected from a phosphate, phosphonate, phosphinate, phosphine, or phosphine oxide having the structure of:

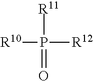

wherein R¹⁰, R¹¹, and R¹², are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, and the second liquid solvent is stable under an applied electrical potential no less than 4 V.

In some embodiments, the second liquid solvent comprises a phosphoranimine having the structure of:

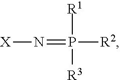

wherein R¹, R², and R³ are independently selected from the group consisting of alkyl, aryl, heteroalkyl, heteroaryl, halogen substituted alkyl, halogen substituted aryl, halogen substituted heteroalkyl, halogen substituted heteroaryl, alkoxy, aryloxy, heteroalkoxy, heteroaryloxy, halogen substituted alkoxy, halogen substituted aryloxy, halogen substituted heteroalkoxy, and halogen substituted heteroaryloxy functional groups, wherein R¹, R², and R³ are represented by at least two different substituents and wherein X is selected from the group consisting of an organosilyl group or a tert-butyl group. The R¹, R², and R³ may be each independently selected from the group consisting of an alkoxy group, and an aryloxy group.

The polymer electrolyte typically has a lithium ion conductivity from 10⁻⁸ S/cm to 10⁻² S/cm at room temperature. The cathode active layer may contain a cathode active material (along with a conductive additive and an optional resin binder). The anode may have no anode active material in the beginning when the battery is made. It may be noted that if no conventional anode active material, such as graphite, Si, SiO, Sn, or conversion-type anode materials, and no lithium metal is present in the battery when the battery is assembled and before the battery begins to charge and discharge, the battery is commonly referred to as an “anode-less” lithium battery.

It may be noted that these first liquid solvents, upon solidification or upon polymerization, become essentially non-flammable. These liquid solvents were typically known to be useful for dissolving a lithium salt and not known for their polymerizability or their potential as an electrolyte polymer.

In some preferred embodiments, the battery contains substantially no volatile liquid solvent therein after polymerization. However, it is essential to initially include a liquid solvent in the cell, enabling the lithium salt to get dissociated into lithium ions and anions. A majority (>50%, preferably >70%) or substantially all of the first liquid solvent (particularly the organic solvent) is then removed (solidified) or polymerized. With substantially 0% liquid solvent, the resulting electrolyte is a solid-state electrolyte. With less than 30% liquid solvent, we have a quasi-solid electrolyte. Both are highly flame-resistant.

A lower proportion of the unpolymerized liquid solvent in the electrolyte leads to a significantly reduced vapor pressure and increased flash point or completely eliminated flash point (un-detectable). Although typically by reducing the liquid solvent proportion one tends to observe a reduced lithium ion conductivity for the resulting electrolyte; however, quite surprisingly, after a threshold liquid solvent fraction, this trend is diminished or reversed (the lithium ion conductivity can actually increase with reduced liquid solvent in some cases).

In certain embodiments, the reactive additive comprises a first polymerizable liquid solvent and a second liquid solvent and wherein the second liquid solvent either is not polymerizable or is polymerizable but polymerized to a lesser extent as compared to the first polymerizable liquid solvent. The presence of this second liquid solvent is designed to impart certain desired properties to the polymerized electrolyte, such as lithium ion conductivity, flame retardancy, ability of the electrolyte to permeate into the electrode (anode and/or cathode) to properly wet the surfaces of the anode active material and/or the cathode active material.

In some embodiments, the first or the second liquid solvent is selected from a fluorinated carbonate, hydrofluoroether, fluorinated ester, sulfone, nitrile, phosphate, phosphite, alkyl phosphonate, phosphazene, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (7-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), or a combination thereof.

Desirable polymerizable liquid solvents can include fluorinated monomers having unsaturation (double bonds or triple bonds) in the backbone or cyclic structure (e.g., fluorinated vinyl carbonates, fluorinated vinyl monomers, fluorinated esters, fluorinated vinyl esters, and fluorinated vinyl ethers). These chemical species may also be used as a second liquid solvent in the presently disclosed electrolyte. Fluorinated vinyl esters include R_{f}CO₂CH═CH₂ and Propenyl Ketones, R_{f}COCCH═CHCH₃, where R_{f} is F or any F-containing functional group (e.g., CF₂— and CF₂CF₃—).

Two examples of fluorinated vinyl carbonates are given below:

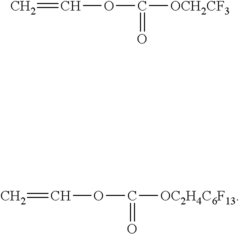

These liquid solvents, as a monomer, can be cured in the presence of an initiator (e.g., 2-Hydroxy-2-methyl-1-phenyl-propan-1-one, Ciba DAROCUR-1173, which can be activated by UV or electron beam):

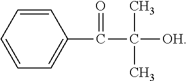

In some embodiments, the fluorinated carbonate is selected from vinyl- or double bond-containing variants of fluoroethylene carbonate (FEC), DFDMEC, FNPEC, hydrofluoro ether (HFE), trifluoro propylene carbonate (FPC), or methyl nonafluorobutyl ether (MFE), wherein the chemical formulae for FEC, DFDMEC, and FNPEC, respectively are shown below:

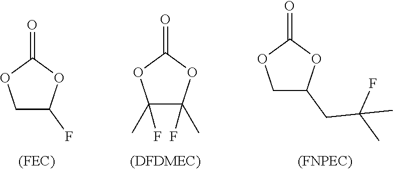

Desirable sulfones or sulfides as a polymerizable first liquid solvent or as a second liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone; some examples are shown below:

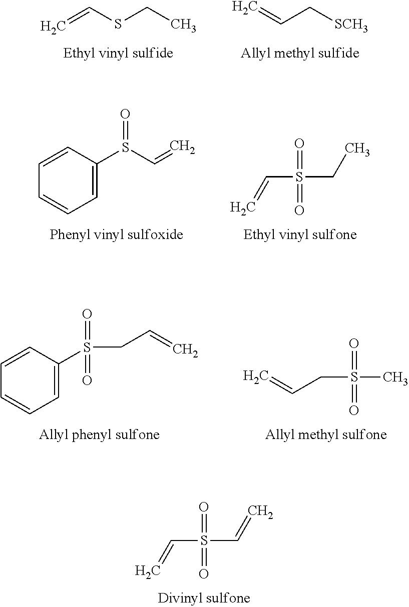

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R=NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

In certain embodiments, the sulfone is selected from TrMS, MTrMS, TMS, or vinyl or double bond-containing variants of TIMS, MTrMS, TMS, EMS, MMES, EMES, EMEES, or a combination thereof; their chemical formulae being given below:

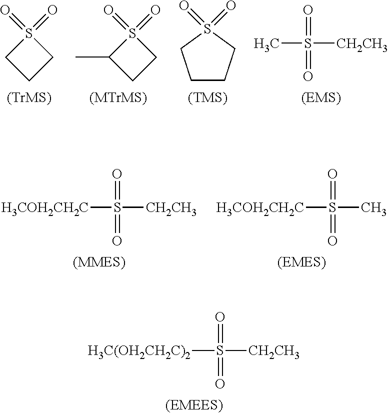

The cyclic structure, such as TrMS, MTrMS, and TMS, can be polymerized via ring-opening polymerization with the assistance of an ionic type initiator.

The nitrile may be selected from AND, GLN, SEN, SN, or a combination thereof and their chemical formulae are given below:

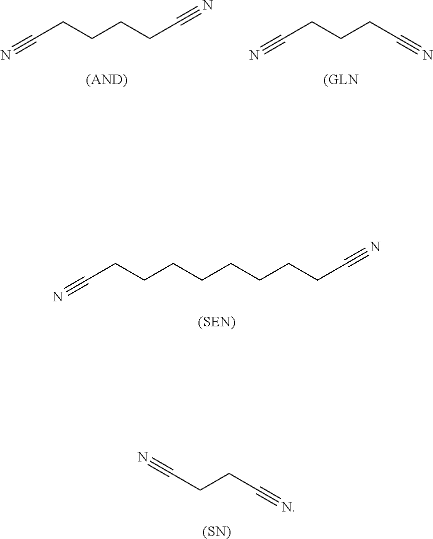

In some embodiments, the phosphate (including various derivatives of phosphoric acid), alkyl phosphonate, phosphazene, phosphite, or sulfate is selected from tris(trimethylsilyl) phosphite (TTSPi), alkyl phosphate, triallyl phosphate (TAP), ethylene sulfate (DTD), a combination thereof, or a combination with 1,3-propane sultone (PS) or propene sultone (PES). The phosphate, alkyl phosphonate, or phosphazene may be selected from the following:

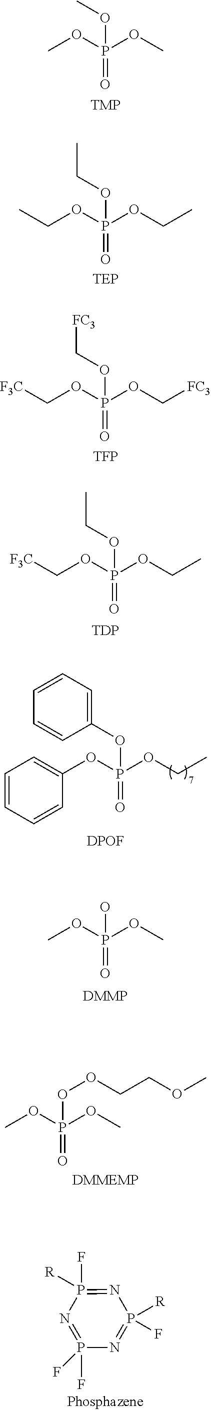

wherein R=H, NH₂, or C₁-C₆ alkyl.

Phosphonate moieties can be readily introduced into vinyl monomers to produce allyl-type, vinyl-type, styrenic-type and (meth)acrylic-type monomers bearing phosphonate groups (e.g., either mono or bisphosphonate). These liquid solvents may serve as a first or a second liquid solvent in the electrolyte composition. The phosphate, alkyl phosphonate, phosphonic acid, and phosphazene, upon polymerization, are found to be essentially non-flammable. Good examples include diethyl vinylphosphonate, dimethyl vinylphosphonate, vinylphosphonic acid, diethyl allyl phosphate, and diethyl allylphosphonate:

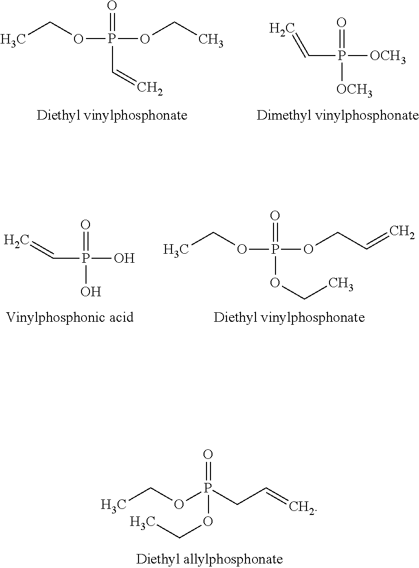

Examples of initiator compounds that can be used in the polymerization of vinylphosphonic acid are peroxides such as benzoyl peroxide, toluy peroxide, di-tert.butyl peroxide, chloro benzoyl peroxide, or hydroperoxides such as methylethyl ketone peroxide, tert, butyl hydroperoxide, cumene hydroperoxide, hydrogen Superoxide, or azo-bis-iso-butyro nitrile, or sulfinic acids such as p-methoxyphenyl-sulfinic acid, isoarnyl-sulfinic acid, benzene-sulfinic acid, or combinations of various of such catalysts with one another and/or combinations for example, with formaldehyde sodium sulfoxylate or with alkali metal sulfites.

The siloxane or silane may be selected from alkylsiloxane (Si—O), alkyylsilane (Si—C), liquid oligomeric silaxane (—Si—O—Si—), or a combination thereof.

The reactive additive or reactive liquid electrolyte may further comprise an amide group selected from N,N-dimethylacetamide, N,N-diethylacetamide, N,N-dimethylformamide, N,N-diethylformamide, or a combination thereof.

In certain embodiments, the crosslinking agent comprises a compound having at least one reactive group selected from a hydroxyl group, an amino group, an imino group, an amide group, an acrylic amide group, an amine group, an acrylic group, an acrylic ester group, or a mercapto group in the molecule.

In certain embodiments, the crosslinking agent is selected from poly(diethanol) diacrylate, poly(ethyleneglycol)dimethacrylate, poly(diethanol) dimethylacrylate, poly(ethylene glycol) diacrylate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)), lithium bis(oxalato)borate (LiBOB), lithium oxalyldifluoroborate (LiBF₂C₂O₄), lithium oxalyldifluoroborate (LiBF₂C₂O₄), or a combination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, or a combination thereof.

In the disclosed polymer electrolyte, the lithium salt may be selected from lithium perchlorate (LiClO₄), lithium hexafluorophosphate (LiPF), lithium borofluoride (LiBF₄), lithium hexafluoroarsenide (LiAsF₆), lithium trifluoro-metasulfonate (LiCF₃SO₃) bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The crosslinking agent preferably comprises a compound having at least one reactive group selected from a hydroxyl group, an amino group, an imino group, an amide group, an amine group, an acrylic group, or a mercapto group in the molecule. The amine group is preferably selected from Chemical Formula 2:

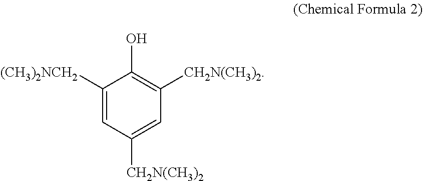

In the electrode or the lithium battery, the reactive additive may further comprise a chemical species represented by Chemical Formula 3 or a derivative thereof and the crosslinking agent comprises a chemical species represented by Chemical Formula 4 or a derivative thereof:

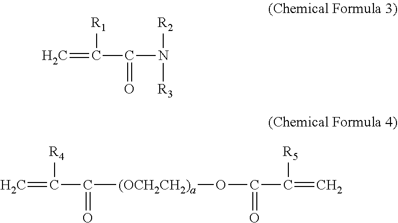

where R₁ is hydrogen or methyl group, and R₂ and R₃ are each independently one selected from the group consisting of hydrogen, methyl, ethyl, propyl, dialkylaminopropyl (—C₃H₆N(R′)₂) and hydroxyethyl (CH₂CH₂ OH) groups, and R₄ and R₅ are each independently hydrogen or methyl group, and n is an integer from 3 to 30, wherein R′ is C₁-C₅ alkyl group.

Examples of suitable vinyl monomers having Chemical formula 3 include acrylamide, N,N-dimethylacrylamide, N,N-diethylacrylamide, N-isopropylacrylamide, N,N-dimethylamino-propylacrylamide, and N-acryloylmorpholine. Among these species, N-isopropylacrylamide and N-acryloylmorpholine are preferred.

The crosslinking agent is preferably selected from N,N-methylene bisacrylamide, epichlorohydrin, 1,4-butanediol diglycidyl ether, tetrabutylammoniun hydroxide, cinnamic acid, ferric chloride, aluminum sulfate octadecahydrate, diepoxy, dicarboxylic acid compound, poly(potassium 1-hydroxy acrylate) (PK-IA), glycerol diglycidyl ether (GDE), ethylene glycol, polyethylene glycol, polyethylene glycol diglycidyl ether (PEGDE), citric acid (Formula 4 below), acrylic acid, methacrylic acid, a derivative compound of acrylic acid, a derivative compound of methacrylic acid (e.g. polyhydroxyethylmethacrylate), glycidyl functions, N,N′-Methylenebisacrylamide (MBAAm), Ethylene glycol dimethacrylate (EGDMAAm), isobornyl methacrylate, poly(acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate (e.g. methylene diphenyl diisocyanate, MDI), an urethane chain, a chemical derivative thereof, or a combination thereof.

There is no particular restriction on the type of inorganic solid-state electrolyte that can be used. The inorganic solid electrolyte material may be selected from an oxide type, sulfide type (including, but not limited to, the thio-LJSICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the hybrid electrolyte include, but are not limited to, perovskite-type, NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓMTi₂₋ₓ(PO₄)₃(M=Al, Cr, Ga, Fe, Sc, In, Lu, Y or La). Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including Li₅La₃M₂O₁₂ (M=Nb or Ta), Li₆A₁La₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer as herein disclosed.

These inorganic solid electrolyte (ISE) particles encapsulated by an elastic electrolyte polymer shell can help enhance the lithium ion conductivity of certain polymers that have a lower ion conductivity than the encapsulated SEI. Preferably and typically, the elastic polymer electrolyte has a lithium ion conductivity no less than 10⁻⁵ S/cm, more desirably no less than 10⁻⁴ S/cm, further preferably no less than 10⁻³ S/cm, and most preferably no less than 10⁻² S/cm.

It should be noted that certain inorganic solid electrolytes (e.g., sulfide type ISE) can have a higher lithium-ion conductivity as compared to certain selected polymers. However, sulfide type ISEs are air-sensitive and air-sensitive and, hence, cannot be combined with an anode active material (e.g., graphite or Si) to form an anode using water as a liquid medium in a commonly used slurry coating process. Furthermore, sulfide-type ISEs have a very narrow electrochemical stability window (e.g., from 1.8-2.5 V relative to Li/Li⁺), making them unsuitable for use in the anode, where lithium ion intercalation occurs at approximately 0.23 V for graphite and 0.5 V for Si (significantly lower than 1.8 V). They are also unsuitable for the cathode since the cathode active material typically operates at 3.2-4.4 V for lithium iron phosphate and all lithium transition metal oxides. We have solved this problem by encapsulating the ISE particles with a polymer electrolyte that typically has a significantly wider electrochemical stability window (e.g., can be from 0 to 4.5 V relative to Li/Li⁺). The polymer protection also enables the ISEs processible using the current lithium-ion cell production processes.

These solid electrolyte particles dispersed in an electrolyte polymer can help enhance the lithium ion conductivity of certain polymers having an intrinsically low ion conductivity.

Preferably and typically, the polymer has a lithium ion conductivity no less than 10⁻⁵ S/cm, more preferably no less than 10⁻⁴ S/cm, and further preferably no less than 10⁻³ S/cm.

The disclosed lithium battery can be a lithium-ion battery or a lithium metal battery, the latter having lithium metal as the primary anode active material. The lithium metal battery can have lithium metal implemented at the anode when the battery is made. Alternatively, the lithium may be stored in the cathode active material and the anode side is lithium metal-free initially. This is called an anode-less lithium metal battery.

As illustrated in FIG. 3(A), the anode-less lithium battery is in an as-manufactured or fully discharged state according to certain embodiments of the present disclosure. The battery comprises multiple cells, wherein a cell comprises a separator (e.g., 15), a cathode active layer (e.g., 16) supported on a cathode current collector (e.g., 18), and an anode current collector (e.g., 17) having one primary surface initially being free from any lithium metal. Each cathode layer comprises a cathode active material, a conductive additive, an optional resin binder (not shown), and an electrolyte (dispersed in the entire cathode layer and in contact with the cathode active material). The cathode current collector (18) supports the cathode active layer (16) on a primary surface, but the anode current collector is tentatively free from a lithium metal layer (as manufactured or in a fully discharged state). There is no lithium metal in the anode side of a unit cell when the battery is manufactured.

In a charged state, as illustrated in FIG. 3(B), the battery cell comprises a lithium metal (20) plated on a primary surface of an anode current collector (17), a separator (15), and a cathode active layer (16) bonded to a cathode current collector (18). The lithium metal comes from the cathode active material (e.g., LiCoO₂ and LiMn₂O₄) that contains Li member when the cathode is made. During a charging step, lithium ions are released from the cathode active material and move to the anode side to deposit onto a primary surface of an anode current collector for forming a lithium metal layer, which is the anode active material.

One unique feature of the presently disclosed anode-less lithium battery is the notion that there is substantially no anode active material and no lithium metal is present when the battery is made. The commonly used anode active material, such as an intercalation type anode material (e.g., graphite, carbon particles, Si, SiO, Sn, SnO₂, Ge, etc.), P, or any conversion-type anode material, is not included in the battery as manufactured. The anode only contains a current collector or a protected current collector. No lithium metal (e.g., Li particle, surface-stabilized Li particle, Li foil, Li chip, etc.) is present in the anode when the battery is made; lithium is basically stored in the cathode (e.g., Li member in LiCoO₂, LiMn₂O₄, lithium iron phosphate, lithium polysulfides, lithium polyselenides, NCA, NCM, etc.). During the first charge procedure after the battery is sealed in a housing (e.g., a stainless steel hollow cylinder or an Al/plastic laminated envelop), lithium ions are released from these Li-containing compounds (cathode active materials) in the cathode, travel through the electrolyte/separator into the anode side, and get deposited on a surface of an anode current collector. During a subsequent discharge procedure, lithium ions leave this surface and travel back to the cathode, intercalating or inserting into the cathode active material.

Such an anode-less battery is much simpler and more cost-effective to produce as compared to the conventional lithium-ion battery since there is no need to have a layer of anode active material (e.g., graphite particles, along with a conductive additive and a binder) pre-coated on the Cu foil surfaces via the conventional slurry coating and drying procedures. The anode materials and anode active layer manufacturing costs can be saved. Furthermore, since there is no anode active material layer (otherwise typically 40-200 μm thick), the weight and volume of the cell can be significantly reduced, thereby increasing the gravimetric and volumetric energy density of the battery. This advantage is in addition to the advantage that there are substantially no connecting wires or cables between two unit cells, further saving the weight, volume, and cost.

Another important advantage of the anode-less battery is the notion that there is no lithium metal in the anode when a lithium metal cell is made. Lithium metal (e.g., Li metal foil and particles) is highly sensitive to air moisture and oxygen and notoriously known for its difficulty and danger to handle during manufacturing of a Li metal battery. The manufacturing facilities should be equipped with special class of dry rooms, which are expensive and significantly increase the battery cell costs.

The primary surface at the anode side of a current collector may be is deposited with multiple particles or coating of a lithium-attracting metal (lithiophilic metal), wherein the lithium-attracting metal, preferably having a diameter or thickness from 1 nm to 10 μm, is selected from Au, Ag, Mg, Zn, Ti, K, Al, Fe, Mn, Co, Ni, Sn, V, Cr, an alloy thereof, or a combination thereof. This deposited metal layer may be further deposited with a layer of protective polymer that covers and protects the multiple particles or coating of the lithiophilic metal. Alternatively, the lithhiophilic metal may be protected by a graphene layer that comprises graphene balls and/or graphene foam. Preferably, the graphene layer has a thickness from 1 nm to 50 μm and/or has a specific surface area from 5 to 1000 m²/g (more preferably from 10 to 500 m²/g). It may be noted that this protective graphene layer (for protecting the lithiophilic metal) is separate and different from the graphene or expanded graphite layer that is directly deposited onto the primary surfaces of a current collector to prevent diffusion of lithium ions through the metal foil; this graphene layer is further discussed below:

A current collector may be coated with a graphene or expanded graphite layer on one primary surface or both primary surfaces to protect against diffusion of lithium ions into the current collector (e.g., a metal foil). This graphene layer may comprise a graphene layer produced via chemical vapor deposition (CVD). The graphene layer may comprise graphene sheets selected from single-layer or few-layer graphene, wherein the few-layer graphene sheets are commonly defined to have 2-10 layers of stacked graphene planes having an inter-plane spacing d₀₀₂ from 0.3354 nm to 0.6 nm as measured by X-ray diffraction. The single-layer or few-layer graphene sheets may contain a pristine graphene material having essentially zero % of non-carbon members, or a non-pristine graphene material having 0.001% to 45% by weight of non-carbon members. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

For a lithium-ion battery featuring the presently disclosed electrolyte, there is no particular restriction on the selection of an anode active material. The anode active material may be selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other members; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobate, lithium-containing titanium oxide, lithium transition metal oxide, ZnCo₂O₄; (f) carbon or graphite particles (g) prelithiated versions thereof; and (h) combinations thereof.

A highly significant observation is that the polymer derived (polymerized) from an otherwise volatile solvent (monomer) can dramatically curtail the amount of volatile solvent molecules that can escape into the vapor phase in a thermodynamic equilibrium condition. In many cases, this has effectively prevented any flammable gas molecules from initiating a flame even at an extremely high temperature. The flash point of the quasi-solid or solid-state electrolyte is typically at least 100 degrees (often >150 degrees) higher than the flash point of the neat organic solvent without polymerization. In most of the cases, either the flash point is significantly higher than 200° C. or no flash point can be detected. The electrolyte just would not catch on fire. Furthermore, any accidentally initiated flame does not sustain for longer than 3 seconds. This is a highly significant discovery, considering the notion that fire and explosion concern has been a major impediment to widespread acceptance of battery-powered electric vehicles. This new technology could significantly impact the emergence of a vibrant EV industry.

In addition to the non-flammability and high lithium ion transference numbers, there are several additional benefits associated with using the presently disclosed quasi-solid or solid-state electrolytes. As one example, these electrolytes can significantly enhance cycling and safety performance of rechargeable lithium batteries through effective suppression of lithium dendrite growth. Due to a good contact between the electrolyte and an electrode, the interfacial impedance can be significantly reduced, Additionally, the local high viscosity induced by the presence of a polymer in the anode can increase the pressure from the electrolyte to inhibit dendrite growth, potentially resulting in a more uniform deposition of lithium ions on the surface of the anode. The high viscosity could also limit anion convection near the deposition area, promoting more uniform deposition of Li ions. These reasons, separately or in combination, are believed to be responsible for the notion that no dendrite-like feature has been observed with any of the large number of rechargeable lithium cells that we have investigated thus far.

As another benefit example, this electrolyte is capable of inhibiting lithium polysulfide dissolution at the cathode and migration to the anode of a Li—S cell, thus overcoming the polysulfide shuttle phenomenon and allowing the cell capacity not to decay significantly with time. Consequently, a coulombic efficiency nearing 100% along with long cycle life can be achieved. When a concentrated electrolyte or crosslinked polymer is used, the solubility of lithium polysulfide will be reduced significantly.

The lithium salt may be selected from lithium perchlorate (LiClO₄), lithium hexafluorophosphate (LiPF₆), lithium borofluoride (LiBF₄), lithium hexafluoroarsenide (LiAsF), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The ionic liquid is composed of ions only. Ionic liquids are low melting temperature salts that are in a molten or liquid state when above a desired temperature. For instance, an ionic salt is considered as an ionic liquid if its melting point is below 100° C. If the melting temperature is equal to or lower than room temperature (25° C.), the salt is referred to as a room temperature ionic liquid (RTIL). The IL-based lithium salts are characterized by weak interactions, due to the combination of a large cation and a charge-delocalized anion. This results in a low tendency to crystallize due to flexibility (anion) and asymmetry (cation).

Some ILs may be used as a co-solvent (not as a salt) to work with the first organic solvent of the present invention. A well-known ionic liquid is formed by the combination of a 1-ethyl-3-methyl-imidazolium (EMI) cation and an N,N-bis(trifluoromethane)sulphonamide (TFSI) anion. This combination gives a fluid with an ionic conductivity comparable to many organic electrolyte solutions, a low decomposition propensity and low vapor pressure up to ˜300-400° C. This implies a generally low volatility and non-flammability and, hence, a much safer electrolyte solvent for batteries.

Ionic liquids are basically composed of organic or inorganic ions that come in an unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide and hexafluorophosphate as anions. Useful ionic liquid-based lithium salts (not solvent) may be composed of lithium ions as the cation and bis(trifluoromethanesulphonyl)imide, bis(fluorosulphonyl)imide and hexafluorophosphate as anions. For instance, lithium trifluoromethanesulfonimide (LiTFSI) is a particularly useful lithium salt.

Based on their compositions, ionic liquids come in different classes that include three basic types: aprotic, protic and zwitterionic types, each one suitable for a specific application. Common cations of room temperature ionic liquids (RTILs) include, but are not limited to, tetraalkylammonium, di, tri, and tetra-alkylimidazolium, alkylpyridinium, dialkyl-pyrrolidinium, dialkylpiperidinium, tetraalkylphosphonium, and trialkylsulfonium. Common anions of RTILs include, but are not limited to, BF₄⁻, B(CN)₄⁻, CH₃BF₃⁻, CH₂CHBF₃⁻, CF₃BF₃—, C₂FSBF₃—, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte co-solvent in a rechargeable lithium cell.

There is also no restriction on the type of the cathode materials that can be used in practicing the present disclosure. For Li—S cells, the cathode active material may contain lithium polysulfide or sulfur. If the cathode active material includes lithium-containing species (e.g., lithium polysulfide) when the cell is made, there is no need to have a lithium metal pre-implemented in the anode.

There are no particular restrictions on the types of cathode active materials that can be used in the presently disclosed lithium battery, which can be a primary battery or a secondary battery. The rechargeable lithium metal or lithium-ion cell may preferably contain a cathode active material selected from, as examples, a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In a rechargeable lithium cell, the cathode active material may be selected from a metal oxide, a metal oxide-free inorganic material, an organic material, a polymeric material, sulfur, lithium polysulfide, selenium, or a combination thereof. The metal oxide-free inorganic material may be selected from a transition metal fluoride, a transition metal chloride, a transition metal dichalcogenide, a transition metal trichalcogenide, or a combination thereof. In a particularly useful embodiment, the cathode active material is selected from FeF₃, FeCl₃, CuCl₂, TiS₂, TaS₂, MoS₂, NbSe₃, MnO₂, CoO₂, an iron oxide, a vanadium oxide, or a combination thereof, if the anode contains lithium metal as the anode active material. The vanadium oxide may be preferably selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. For those cathode active materials containing no Li member therein, there must be a lithium source implemented in the cathode side to begin with. This can be any compound that contains a high lithium content, or a lithium metal alloy, etc.

In a rechargeable lithium cell (e.g., the lithium-ion battery cell), the cathode active material may be selected to contain a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

Particularly desirable cathode active materials comprise lithium nickel manganese oxide (LiNiₐMn₂₋ₐO₄, 0<a<2), lithium nickel manganese cobalt oxide (NCM or LiNiₙMnₘCo₁₋ₙ₋ₘO₂, 0<n<1, 0<m<1, n+m<1), lithium nickel cobalt aluminum oxide (NCA or LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

In a preferred lithium metal secondary battery, the cathode active material preferably contains an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof. Again, for those cathode active materials containing no Li member therein, there must be a lithium source implemented in the cathode side to begin with.

In another preferred rechargeable lithium battery (e.g. a lithium metal secondary battery or a lithium-ion battery), the cathode active material contains an organic material or polymeric material selected from Poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material (redox-active structures based on multiple adjacent carbonyl groups (e.g., “C₆O₆”-type structure, oxocarbons), Tetracyanoquinodimethane (TCNQ), tetracyanoethylene (TCNE), 2,3,6,7,10,11-hexamethoxytriphenylene (I-LMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Flexaazatrinaphtylene (HIATN), Hexaazatriphenylene hexacarbonitrile (HAT(CN)6), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer may be selected from Poly[methanetetryl-tetra(thiomethylene)](PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that consist of conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly[1,2,4,5-tetrakis(propylthio)benzene] (PTKPTB) have a polyphenylene main chain, linking thiolane on benzene moieties as pendants. Similarly, poly[3,4(ethylenedithio)thiophene] (PEDTT) has polythiophene backbone, linking cyclo-thiolane on the 3,4-position of the thiophene ring.

In yet another preferred rechargeable lithium battery, the cathode active material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. This class of lithium secondary batteries has a high capacity and high energy density. Again, for those cathode active materials containing no Li member therein, there must be a lithium source implemented in the cathode side to begin with.

In certain embodiments, the present disclosure provides a method of producing the aforementioned battery pack, the method comprising:
(a) Providing a first set of multiple positive electrodes (cathodes), multiple negative electrodes (anodes), and multiple ion-conducting separator layers, wherein the positive electrode comprises (i) a cathode current collector (CCC) comprising a first conductive material foil having a thickness from 10 nm to 100 μm and two opposing primary surfaces, herein referred to as a first primary surface and a second primary surface, respectively; and (ii) a cathode active layer (CAL) deposited on the first primary surface and in physical or ionic contact with the separator, wherein the cathode active layer comprises a mixture of particles of a cathode active material, a conductive additive, an optional binder resin, and a first polymer electrolyte having a lithium salt dispersed therein, which is a solid polymer electrolyte or gel polymer electrolyte, having a lithium ion conductivity no less than 1.0×10⁻⁸ S/cm at room temperature (preferably from 1.0×10⁻⁶ S/cm to 5.0×10⁻² S/cm); and
   wherein the negative electrode comprises (iii) an anode current collector (ACC) comprising a second conductive material foil having a thickness from 10 nm to 100 μm and two opposing primary surfaces, herein referred to as a third primary surface and a fourth primary surface, respectively; and (iv) an optional anode active layer (AAL), deposited on the third primary surface and in physical or ionic contact with the separator, the negative electrode layer (if present) comprising a lithium metal layer or a layer of a mixture of particles of an anode active material, an optional conductive additive, an optional binder resin, a second polymer electrolyte having a lithium salt dispersed therein, which is different than or the same as the first polymer electrolyte and is a solid polymer electrolyte or gel polymer electrolyte having a lithium ion conductivity no less than 1.0×10⁻⁸ S/cm at room temperature (preferably from 1.0×10⁻⁶ S/cm to 5.0×10⁻² S/cm);
(b) stacking the multiple positive electrodes (PE), multiple negative electrodes (NE), and multiple ion-conducting separator layers (SL) according to the sequence of [PE-SL-NE]ₘ, where m is an integer equal to or greater than 2, wherein a separator layer is disposed between, and in ionic communication with, a negative electrode layer and a positive electrode layer and wherein a cathode current collector is in a physical and electronic contact with a neighboring negative current collector;
(c) applying a pressure, heat, or both pressure and heat to the stack for a desired period of time to consolidate the stack for forming a battery module; and
(d) optionally encasing the module with a protective housing member to form a pack.
   In some embodiments, step (b) and step (c) are repeated to form at least another module in a similar manner and the resulting multiple modules are internally connected in parallel to form a pack, and step (d) comprises encasing the parallel-connected multiple modules with a protective housing member to form a encased pack.

In certain embodiments, the pressure in step (c) is from 0.1 to 1,000 psi, the temperature is from 25° C. to 400° C., and the period of time is from 10 seconds to 5 hours. The temperature needed depends upon the proper dissolution temperature or the glass transition or melting point of the polymer. The magnitude of the pressure applied to the stack/module or pack depends upon the type of polymer electrolyte used. A lower pressure would be needed if the polymer electrolyte contains some liquid or is a gel polymer electrolyte. We have observed that the application of a pressure on the stack or module can significantly reduce the internal impedance or resistance of a battery module. The internal resistance of the entire pack, comprising multiple modules connected in parallel, is also reduced, enabling significantly improved power density. This pressure can be exerted onto modules, along the module stacking direction (e.g., perpendicular to the plane), using means such as roll-pressing, hydraulic power driven compressing press, and hydrostatic pressing.

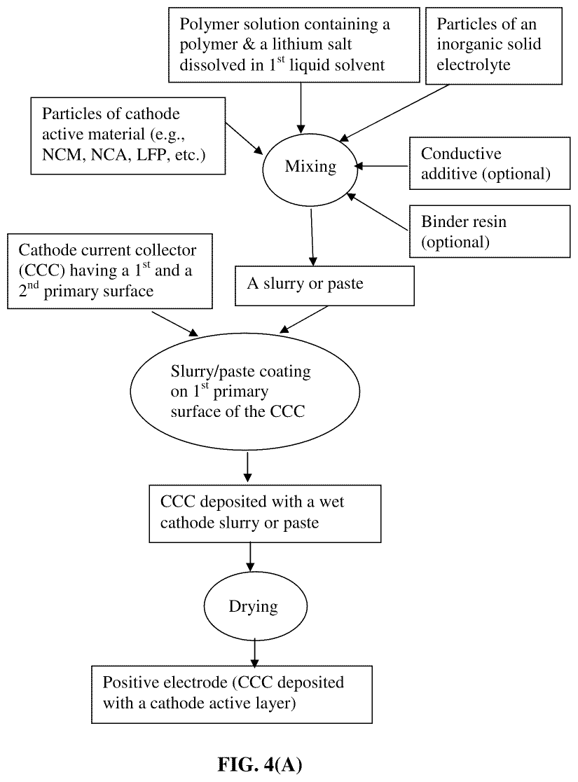

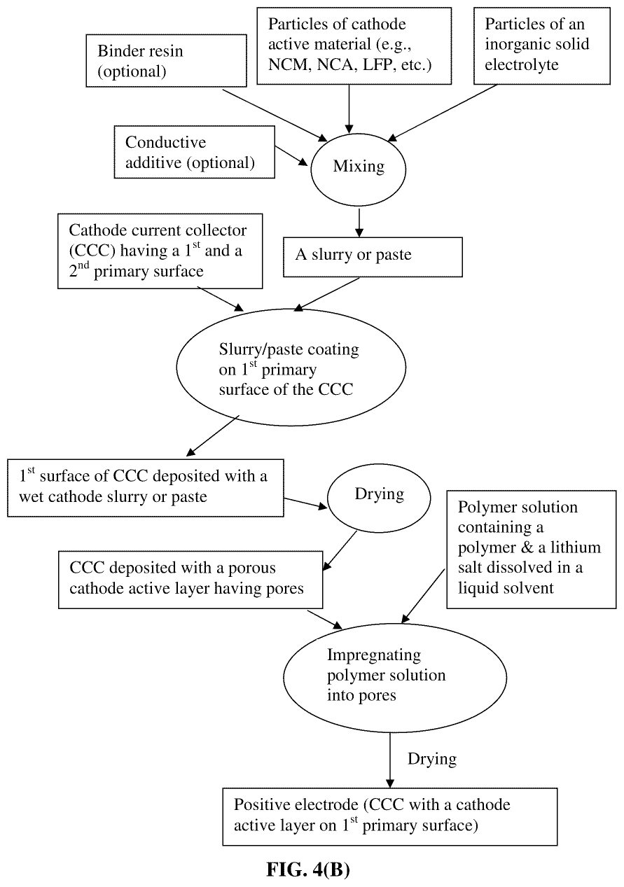

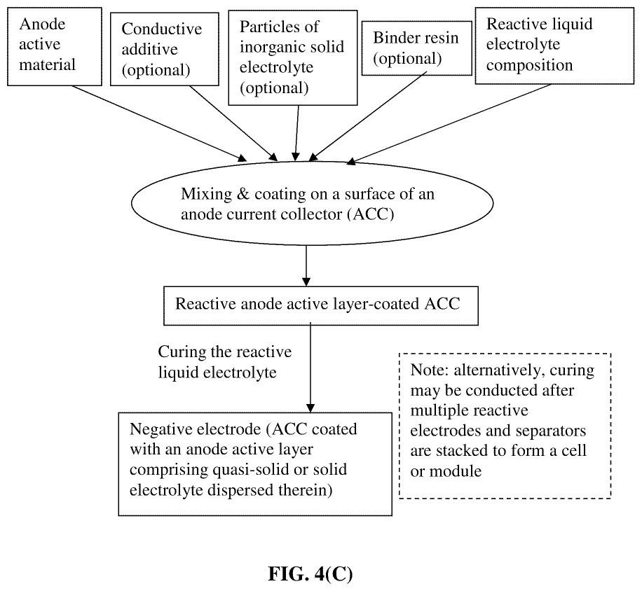

As schematically illustrated in FIG. 4(B), the positive electrode (cathode) active layer in step (a) may be produced by (i) mixing and dispersing particles of a cathode active material, particles of a solid inorganic solid-state electrolyte, an optional resin binder, and an optional conductive additive in a liquid medium (e.g., NMP) to form a liquid slurry; (ii) depositing a layer of slurry on the first primary surface of the current collector; (iii) removing the liquid medium from the slurry layer to obtain a porous positive electrode layer containing from 1% to 50% by volume of pores; (iv) preparing a first polymer solution comprising a polymer and a lithium salt dissolved in a first liquid solvent having a polymer-to-lithium salt weight ratio of from 1/100 to 100/1, wherein the polymer has a lithium-ion conductivity no less than 10⁻⁸ S/cm; and (v) impregnating the polymer solution into pores of the porous positive electrode layers and partially or totally removing the first liquid solvent from the positive electrode layer to obtain the positive electrode. In this procedure, steps (i)-(iii) is similar to the conventional slurry coating process for producing a cathode (positive electrode) of a lithium-ion cell. However, steps (iv) and (v) are totally new and distinct from the remaining procedures of the conventional lithium ion cell production process.

A negative electrode (anode) may be produced in a similar manner, but with the cathode active material being replaced by an anode active material. For instance, the negative electrode (anode) layer in step (a) is produced by (i) mixing and dispersing particles of an anode active material, optional particles of a solid inorganic solid-state electrolyte, an optional resin binder, and an optional conductive additive in a liquid medium to form a liquid slurry; (ii) depositing a layer of slurry on a second primary surface of the current collector; (iii) removing the liquid medium from the slurry layer to obtain the negative electrode layer containing from 1% to 50% by volume of pores; and (iv) impregnating the pores with a polymer electrolyte. Step (iv) may be accomplished by preparing a second polymer solution comprising a second polymer and a lithium salt dissolved in a second liquid solvent (the same as or different than the first liquid solvent) having a polymer-to-lithium salt weight ratio of from 1/100 to 100/1, wherein the second polymer (the same as or different than the first polymer) has a lithium-ion conductivity no less than 10⁻⁸ S/cm; and (v) impregnating the second polymer solution into pores of the porous positive electrode layers and partially or totally removing the second liquid solvent from the negative electrode layer to obtain the electrode.

Alternatively, as schematically illustrated in FIG. 4(A), the positive electrode active layer in step a) may be produced by (i) mixing, dispersing, or dissolving particles of a cathode active material, particles of a solid inorganic solid-state electrolyte, an optional resin binder, an optional conductive additive, and a first electrolyte polymer in a first liquid solvent to form a liquid slurry, wherein the first electrolyte polymer has a lithium-ion conductivity no less than 10⁻⁸ S/cm; (ii) depositing a layer of slurry on the first primary surface of the current collector; and (iii) partially or completely removing the first liquid solvent from the slurry layer to obtain the positive electrode active layer.

A negative electrode (anode) may be produced in a similar manner, but with the cathode active material being replaced by an anode active material. The negative electrode layer in step (a) may be produced by (i) mixing, dispersing, or dissolving particles of an anode active material, optional particles of a solid inorganic solid-state electrolyte, an optional resin binder, an optional conductive additive, and a electrolyte polymer in a liquid solvent to form a liquid slurry; (ii) depositing a layer of slurry on the opposing primary surface of the current collector; and (iii) partially or completely removing the liquid solvent from the slurry layer to obtain the negative electrode layer.

As schematically illustrated in FIG. 4(C), in some embodiments, the negative electrode active layer in step (a) may be produced by (i) depositing a reactive anode layer onto a primary surface of an anode current collector to form a reactive anode layer-coated current collector, wherein the reactive anode layer comprises a mixture of multiple particles of an anode active material, an optional conductive additive, and a reactive liquid electrolyte composition comprising at least a polymerizable first liquid solvent, a lithium salt dissolved in the first liquid solvent, and a crosslinking agent and/or an initiator, wherein the first liquid solvent occupies from 1% to 99% by weight based on the total weight of the reactive liquid electrolyte composition; and (ii) partially or totally polymerizing the first liquid solvent to obtain an anode active layer coated on the current collector wherein from 30% to 100% by weight of the polymerizable first liquid solvent is polymerized to become a quasi-solid or solid-state electrolyte that chemically bonds the multiple particles of the anode active material and the conductive additive together to form an anode active layer that adheres to the second primary surface. A positive electrode may be made in a similar in situ curing procedure.

The first polymerizable liquid solvent may be selected from the group consisting of vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, and combinations thereof.

In some preferred embodiments, the process associated with the method (step (a), for instance) is conducted in a roll-to-roll manner to produce a roll of electrode. One can then un-wind the roll, cut and trim into a desired number of electrodes of desired dimensions. Alternatively, one can produce one or multiple electrodes of desired dimensions at a time using a machine system, Slurry coating, casting or spraying and drying machines are well-known in the art.

Preferably, the process is a roll-to-roll process wherein the process comprises (i) continuously feeding a layer of the solid substrate (e.g. graphene-coated Al foil) from a feeder roller to a dispensing zone where the reactive mass (e.g., mixture of a reactive electrolyte composition, cathode active material particles, and conductive filler) is dispensed and deposited onto a primary surface of the solid substrate to form a continuous layer of the reactive mass; and (ii) moving the layer of the reactive mass into a reacting zone where the reactive mass is exposed to heat, ultraviolet (UV) light, or high-energy radiation to polymerize and/or cure the reactive mass to form a continuous layer of electrode-coated current collector. This process is conducted in a reel-to-reel manner.

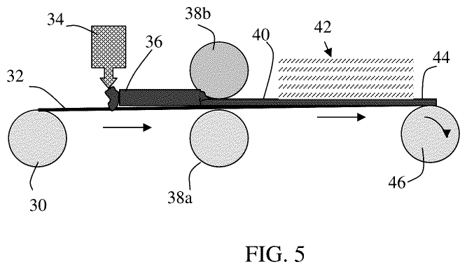

In certain embodiments, as illustrated in FIG. 5, the roll-to-roll process may begin with continuously feeding a solid substrate layer 32 (e.g., graphene- or expanded graphite-coated Al foil) from a feeder roller 30. A dispensing device 34 is operated to dispense and deposit a polymer solution-based slurry/paste (e.g., cathode active material particles, particles of an inorganic solid electrolyte, conductive additive, and a polymer solution comprising a polymer and a lithium salt dissolved in a liquid medium) or a reactive mass 36 (e.g., reactive or curable cathode layer) onto the solid substrate layer 32, which is driven toward a pair of rollers (38a, 38b). These rollers are an example of a provision to regulate or control the thickness of the reactive mass 40. The slurry/paste layer or reactive mass 40, supported on the solid substrate, is driven to move through a reacting zone 42 which is provided with a heating or curing means (heat, UV, IP, high energy radiation, etc.). The partially or fully cured or solidified polymer composite 44 is collected on a winding roller 46. An anode layer may be deposited before or after the cathode layer is cured so that the anode layer may be cured or solidified concurrently or separately. The anode layer may be just a layer of lithium metal or a lithium metal-protecting polymer that can be deposited using vapor deposition, sputtering, spraying, etc. One may unwind the roll at a later stage.

The process may further comprise cutting and trimming the continuous layer of electrode into one or multiple pieces of electrodes. The process may further comprise combining multiple electrodes and separators into a lithium battery.

The separator may comprise a polymer, inorganic, or composite solid electrolyte; it may simply comprise a porous polymer membrane. In certain embodiments, the separator comprises polymeric fibers, ceramic fibers, glass fibers, or a combination thereof. These fibers may be stacked together in such a manner that there are pores that allow for permeation of lithium ions, but not for penetration of any potentially formed lithium dendrites. These fibers may be dispersed in a matrix material or bonded by a binder material. This matrix or binder material may contain a ceramic or glass material. The polymer electrolyte herein disclosed may serve as the matrix material or binder material that helps to hold these fibers together. The separator may contain particles of a glass or ceramic material (e.g., metal oxide, metal carbide, metal nitride, metal boride, etc.).

In summary, the disclosure also provides a method of producing a battery pack, the method comprising (a) preparing multiple positive electrodes each comprising a cathode active layer supported by a cathode current collector, multiple ion-conducting separators, and multiple negative electrodes each comprising an optional anode active layer supported by an anode current collector, wherein at least one of the cathode active layer, the anode active layer, and the separator comprises a polymer electrolyte or a polymer composite electrolyte; (b) stacking the positive electrodes, separators and negative electrodes sequentially to form a battery stack comprising multiple unit cells internally connected in series; (c) exerting a pressure along a stacking direction or a pressure and heat to the battery stack to form a module; and (d) optionally encasing the module with a protective housing member to form a pack.

Step (a), step (b) and step (c) may be repeated to form multiple modules and the method further comprises internally connecting the resulting multiple modules in parallel, and step (d) comprises encasing the parallel-connected multiple modules with a protective housing member to form a pack.

The disclosure further discloses a method of producing a battery pack, wherein the method comprises stacking pack components in at least one of the following three sequences: (i) layer-by-layer, (ii) electrode-separator-electrode, and (iii) cell-by-cell sequences.

The following examples are presented primarily for the purpose of illustrating the best mode practice of the present invention, not to be construed as limiting the scope of the present invention. In the present study, the conductive additive in the electrodes was typically selected from carbon black or acetylene black (e.g., Super-P), carbon nanotubes (CNTs), or graphene sheets, unless otherwise specified.

### Example 1: Preparation of Inorganic Solid Electrolyte (ISE) Powder, Lithium Nitride Phosphate Compound (LIPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. These ISE particles can be combined with a polymer to form hybrid solid-state electrolyte particulates for use in an anode, a cathode, and/or a separator.

### Example 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte material was then subjected to grinding in a mortar to form a powder sample to be later added as inorganic solid electrolyte particles encapsulated by an intended polymer electrolyte shell.

### Example 3: Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J, van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃·9H₂O, La(NO₃)₃₋₆(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was encapsulated in several ion-conducting polymers.

### Example 4: Preparation of Sodium Superionic Conductor (NASICON) Type Inorganic Solid Electrolyte Powder

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed includes of two sequential steps. Firstly, solid solutions of alkaline earth metal oxides (MO) and ZrO₂ were synthesized by high energy ball milling at 875 rpm for 2 h. Then NAS ICON Na_{3.1}AZr_{1.95}Mo_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### Example 5: Production of Electrodes Comprising Poly(Vinylidene Fluoride)-Hexafluoropropylene (PVDF-HFP) as a Polymer Electrolyte and LGPS as the Inorganic Solid-State Electrolyte

PVDF-HFP is dissolvable in a liquid solvent such as N,N′-dimethylformamide (DMF), N-methylpyrrolidone (NMP), dimethyl sulfoxide (DMSO), and acetone. We chose to use a mixture of DMSO and acetone (1/1volume ratio) to dissolve a lithium salt (LiPF₆) up to a mole ratio of 0.8 at 45° C. and to dissolve PVDF-HFP up to 3% by weight to obtain a polymer solution. Then, 5% by weight (relative to the intended total composite layer weight) of nano particles of an inorganic solid-state electrolyte (LGPS prepared in Example 2), 1% by weight of carbon nanotubes (CNTs), 1% reduced graphene oxide sheets (from Angstron Materials, Inc.),10% by weight of PVDF-HVP/LiPF₆, and 83% by weight of lithium iron phosphate (LFP) particles were dispersed in the polymer solution to obtain a slurry having a solid content of 10% by weight. The slurry was slot-die coated onto a first primary surface of a graphene-coated Al foil and dried in a vacuum oven at 65° C. overnight to obtain a cathode active layer-coated current collector (a positive electrode). Several samples were prepared.

To match with one set of positive electrodes, the primary surfaces of anode current collectors (Cu foil as an example) were left empty (without any anode active layer). Multiple positive and negative electrodes (5 each of them here) were then internally connected in series in such a manner that a polymer composite separator (specified below) was then disposed between a cathode active layer of one positive electrode and an empty primary surface of a neighboring anode current electrode. Such a structure is essentially an anodeless battery module.

In another set of samples, a primary surface of the Cu foil was deposited with an anode layer comprising 83% of graphene-protected Si anode particles (from Honeycomb Battery Co., Dayton, Ohio), 2% by weight of carbon nanotubes (CNTs), 5% by weight of LGPS particles, and 10% by weight of PVDF-HVP/LiPF₆.

Further, specimens of a separator (solid-state electrolyte) comprising 1/3 of PVDF-HVP/LiPF₆ and 2/3 of LGPS particles were prepared in a similar manner, but no electrode active material and no electron-conducting additive were included. The multiple layers of positive electrodes, separator layers, and negative electrodes were then alternately stacked (according to the sequence of FIG. 2(A)) and heated to 180° C. for 5 minutes under a pressure of 20 psi and subsequently cooled to room temperature to prepare a battery module. The anode active layers, the separator layers, and the cathode active layers in this module have the same PVDF-HFP-based polymer electrolyte.

A different set of battery modules were prepared by preparing multiple Type-I unit cells first, which were then stacked and internally connected to form individual modules. In this case, a Cu foil (an anode current collector) and an Al foil (a cathode current collector) were mated surface-to-surface and mechanically bonded together when a unit cell is made. The stack was heated to 180° C. for 5 minutes under a pressure of 20 psi and subsequently cooled to room temperature to prepare a battery module. Multiple modules were then connected in parallel to form a pack according to FIGS. 2(B) and 2(C).

### Example 6: Production of Poly(Acrylonitrile)-Based NCM-622 Cathode Layer

Poly(acrylonitrile) (PAN) is soluble in polar solvents, such as dimethylformamide (DMF), dimethylacetamide (DMAc), ethylene carbonate (EC) and propylene carbonate (PC), and in aqueous solutions of sodium thiocyanate, zinc chloride or nitric acid. The present study primarily made use of DMAc and EC as a solvent. A lithium salt (LiPF₆) was dissolved in EC for up to a mole ratio of 1.2 at 45° C. On a separate basis, 5% by weight of PAN was dissolved in EC to make a polymer solution. The EC/LiPF₆ solution was then mixed with the EC/PAN solution to form a mixture solution. Nano particles of LLZO (obtained in Example 3), along with cathode active material particles (NCM-622) and graphene sheets (as a conductive additive), were then dispersed in the mixture solution to obtain a slurry having a solid content of 4.5%. The amounts of particles and additives were added for the purpose of reaching the following weight %: LLZO (8%), PAN (10%), graphene sheets (2%), and NCM-622 (80%) in the polymer composite. The slurry was coated onto a primary surface of a graphene-coated Al foil and dried to form a cathode active layer.

A separate set of samples were prepared by using a conventional slurry coating procedure to produce a porous cathode layer on a first primary surface of a cathode current collector. In this procedure, particles of LLZO, NCM-622 cathode material, graphene sheets, and PVDF (as a binder resin) were dispersed in NMP solvent to form a slurry. A layer of slurry was then coated on a surface of Al foil; upon drying a cathode layer was formed having pores. The same mixture solution of EC/PAN/LiPF₆ was then sprayed over the porous cathode layer, allowing the solution to permeate into pores. The solvent was then removed with heat and a vacuum pump, leaving behind PAN containing LiPF₆ dispersed therein.

For the preparation of an ion-conducting separator, LLZO particles were dispersed in the EC/LiPF₆/PAN solution to form a paste, which was cast onto a glass surface to form a paste layer. The layer was then dried by vaporizing the solvent to form a separator which is a polymer composite electrolyte. Essentially five positive electrode layers (each having a cathode layer deposited on one primary surface of a graphene-coated Al foil), 4 separator layers, and 5 Cu foil layers (with no anode layer deposited on the primary surfaces of each Cu foil) were alternately stacked and series-connected to form a stack of unit cells. The stack was then subjected to a compressive stress (pressure of approximately 70 psi) using a hydraulic press for 5 minutes to make a consolidated anodeless lithium battery module. This module was then enclosed by a plastic-Al laminate envelop to make a battery pouch having two terminals sticking out of the protective housing.

### Example 7: Lithium Metal Battery Module/Pack Featuring an In Situ Polymerized VC or FEC as the First Liquid Solvent in an Anode Layer of a Negative Electrode

In one example, vinylene carbonate (VC) or fluoroethylene carbonate (FEC) as a first liquid solvent, TEP as a second liquid solvent (flame retardant), and poly(ethylene glycol) diacrylate (PEGDA) as a crosslinking agent were stirred under the protection of argon gas until a homogeneous solution was obtained. The TEP has the following chemical structure:

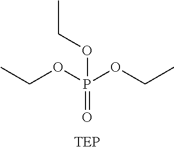

Subsequently, lithium hexafluoro phosphate, as a lithium salt, was added and dissolved in the above solution to obtain a reactive mixture solution, wherein the weight fractions of VC or FEC, TEP, polyethylene glycol diacrylate, and lithium hexafluoro phosphate were 80 wt %, 5 wt %, 10 wt %, and 5 wt %, respectively.

Particles of SiOₓ, particles of Li₇La₃Zr₂O₁₂, a conductive additive (multi-walled carbon nano-tubes), and one of the above reactive electrolyte solutions were mixed to form a reactive anode, which was coated on one primary surface of an Al foil (a product of Global Graphene Group, Inc., Dayton, Ohio), as an anode current collector, to form a negative electrode. A primary surface of a graphene-coated Al foil (as a cathode current collector) was deposited with a cathode active layer by following the procedure described in Example 5.

Layers of a solid-state electrolyte-based separator composed of particles of Li₇La₃Zr₂O₁₂embedded in a polyvinylidene fluoride matrix (inorganic solid electrolyte/PVDF ratio=4/6) were then prepared. Three positive electrodes, two separators, and three negative electrodes were then stacked together to form a lithium battery module containing uncured liquid electrolyte in the anode layers.

The battery module was then irradiated with electron beam at room temperature until a total dosage of 40 Gy was reached. In-situ polymerization of the polymerizable first liquid solvent in the battery cell was accomplished, resulting in a quasi-solid electrolyte that permeates into the anode to wet the surfaces of SiO, particles.

### Example 8: Vinyl Ethylene Sulfite (VES) as the First Solvent and Hydrofluoro Ether (HFE) as the Second Solvent

Under the protection of an argon gas atmosphere, vinyl ethylene sulfite (VES), hydrofluoro ether (HFE), and tetra(ethylene glycol) diacrylates were stirred evenly to form a solution. Bis trifluoromethyl sulfimide lithium was then dissolved in the solution to obtain a solution mixture. In this solution mixture, the weight fractions for the four ingredients were VEC (40%), HFE (20%), tetra(ethylene glycol) diacrylates (20%), and bis trifluoromethyl sulfimide (10%).

The mixed solution was added to a lithium-ion battery having four unit cells connected in series; each having a cathode (comprising NCM-622, particles of inorganic electrolyte Na_{3.1}Zr_{1.95}M_{0.05}Si₂PO₁₂, CNTs as a conductive additive, and polyethylene oxide electrolyte, PEO) on one primary surface of an expanded graphite-coated Al foil (prepared according to a procedure described in Example 6), a separator (a composite membrane comprising Na_{3.1}Zr_{1.95}M_{0.05}Si₂PO₁₂ and PEO), and a graphite-based anode on one primary surface of a Cu foil. These electrodes and separators were assembled after the mixed solution was sprayed and impregnate into the negative electrodes (anodes); the mixed solution accounted for 3% of the total battery weight. The battery was exposed to electron beam at 50° C. until a dosage of 20 kGy was reached. VEC was polymerized and crosslinked to become a solid polymer, but HFE remained as a liquid.

### Example 9: Lithium-Ion Battery Pack Featuring an In Situ Polymerized Phenyl Vinyl Sulfide (PVS) in the Presence of a Second Solvent TMS (PVS/TMS Ratio=9/1−9/5)

TMS has the following chemical formula:

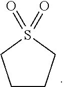

The lithium-ion battery modules prepared in this example each comprise five unit cells internally connected in series. Each positive electrode comprises a graphene composite-coated Al as a current collector. One primary surface was coated with a cathode layer of NCM-622 particles as obtained in Example 5.

A primary surface of a stainless steel foil (as an anode current collector) is coated with an anode layer of meso-carbon micro-beads (MCMB, an artificial graphite supplied from China Steel Chemical Co. Taiwan) and an SBR binder. This anode layer was prepared by following the well-known slurry coating, following by heat-drying to remove the liquid medium (water) to obtain a porous anode layer having pores.

Phenyl vinyl sulfide (first liquid solvent), TMS (second solvent), CTA (chain transfer agent, shown below), AIBN (initiator, 1.0%), and 5% by weight of lithium trifluoro-metasulfonate (LiCF₃SO₃), were mixed and impregnated into the porous anode layer, and heated at 60° C. to obtain a battery cell containing an in situ cued polymer electrolyte.

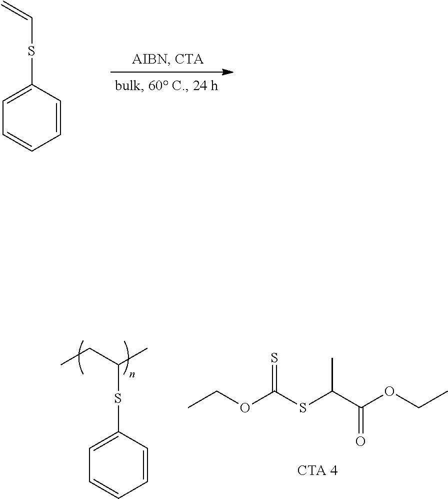

A porous PE/PP membrane impregnated with a reactive liquid electrolyte was used as a separator disposed between an anode active layer of a negative electrode and a cathode active layer of a neighboring positive electrode.

Three modules (each having 5 basic unit cells connected internally in series) prepared in this manner were then connected in parallel to form a pack.

### Example 10: Lithium-Ion Battery Modules/Packs Featuring an In Situ Polymerized Phenyl Vinyl Sulfone

The lithium-ion battery modules prepared in this example each comprise 13 unit cells to deliver a battery output voltage of 48 volts. Each unit cell includes an anode layer made of graphene-protected Si particles, a porous PE/PP membrane as a separator, and a cathode active of NCM-622 particles coated on a cathode current collector as prepared in Example 6. The anode layer was prepared via in-situ curing in a procedure similar to that in Example 9; but the polymer was PVS.

Phenyl vinyl sulfone (PVS) can be polymerized with several anionic-type initiators; e.g., n-BuLi, ZnEt2, LiN(CH₂)₂, and NaNH₂. The second solvent may be selected from pyridine, sulfolane, Trimethyl phosphate (TMP), Trifluoro-Phosphate (TFP), etc. Trimethyl phosphate has the following chemical structure:

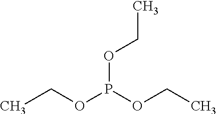

A mixture of PVS, TFP, n-BuLi (1.0% relative to PVS), and LiBF₄ (0.5 M) was thoroughly mixed and impregnated into the negative electrodes prior to stacking of electrodes and separators. The battery modules were maintained at 30° C. overnight to cure the PVS solvent.

### Example 11: Battery Packs Containing Quasi-Solid and Solid-State Electrolytes from Vinylphosphonic Acid (VPA)

The free radical polymerization of vinylphosphonic acid (VPA) can be catalyzed with benzoyl peroxide as the initiator. In a representative procedure, 150 parts vinylphosphonic acid, 0.75 parts benzoyl peroxide, and 20 parts of lithium bis(oxalato)borate (LiBOB) were dissolved in 150 parts isopropanol. For the preparation of lithium battery modules, dry porous cathode electrodes and dry porous anode electrodes were injected with the reactive mass, followed by removal of most of the isopropanol and, in some cases, replaced with TFP as a second solvent.

In a separate experiment, vinylphosphonic acid was heated to >45° C. (melting point of VPA=36° C.), which was added with benzoyl peroxide, LiBOB, and 25% by weight of a garnet-type solid electrolyte (Li₇La₃Zr₂O₁₂ (LLZO) powder). After rigorous stirring, the resulting paste was cast onto a glass surface and cured at 90° C. for 5 hours to form a solid electrolyte separator to be disposed between an anode active and a cathode active layer.

For a lithium-ion battery, a natural graphite-based anode active layer was coated onto a Cu foil to form a negative electrode, and a LiCoO₂-based cathode active layer was deposited onto an Al foil to form a positive electrode. This was obtained by following a procedure similar to that in Example 5 (impregnating a polymer solution into pores of a dried cathode layer or anode layer, followed by solvent removal). For an anode-less lithium battery, a LiCoO₂-based cathode layer was deposited on one primary surface of the expanded graphite-coated Al foil, but the primary surfaces of a Cu foil were not deposited with any lithium metal when the battery was made. Multiple (10) positive electrodes, 9 solid electrolyte separator layers, and 10 negative electrodes were assembled into a battery module. The module was then heated for 5 hours at 90° C. under a light pressure to form polyvinylphosphonic acid, mixed with 5% by weight TFP.

Electrochemical measurements (CV curves) were carried out in an electrochemical workstation at a scanning rate of 1-100 mV/s. The electrochemical performance of the batteries was evaluated by galvanostatic charge/discharge cycling at a current density of 50-500 mA/g using an Arbin electrochemical workstation. Testing results indicate that the batteries containing quasi-solid or solid-state electrolytes obtained by in situ curing perform very well, having higher energy densities and power densities as compared to battery modules having conventional liquid electrolyte-based lithium cells connected in series via wires. These batteries are flame resistant and relatively safe.

### Example 12: In Situ Cured Diethyl Vinylphosphonate and Diisopropyl Vinylphosphonate Polymer Electrolytes in a Lithium/NCM-532 Battery (Initially the Cell being Lithium-Free) and a Lithium-Ion Battery Containing a Si-Based Anode and an NCM-532 Cathode

Both diethyl vinylphosphonate and diisopropyl vinylphosphonate can be polymerized by a peroxide initiator (di-tert-butyl peroxide), along with LiBF₄, to clear, light-yellow polymers of low molecular weight. In a typical procedure, either 85% by weight of diethyl vinylphosphonate or diisopropyl vinylphosphonate (being a liquid at room temperature) and 5% of a second liquid solvent (unsaturated phosphazene) were added with di-tert-butyl peroxide (1% by weight) and LiBF₄ (9% by weight) to form a reactive electrolyte solution. The electrolyte solution was heated to 45° C. and mixed with anode active material particles (graphene-coated Si particle) and acetylene black particles to form an anode layer that is deposited on one primary surface of a Cu foil current collector (for a lithium-ion battery). Bulk polymerization was allowed to proceed for 2-12 hours inside the anode.

A layer of cathode active material (NCM-522 particles) was made in a manner described in Example 6 (polymer solution impregnation into pores of a porous cathode layer, followed by removal of the liquid medium from the polymer solution) and coated onto a primary surface of an Al foil current collector. For the construction of an anode-less lithium metal battery, the anode current collector was free from anode active material when the battery was made.

Layers of diethyl vinylphosphonate and diisopropyl vinylphosphonate polymer electrolytes were cast on glass surfaces and polymerized for 3 hours. Bulk polymerization was allowed to proceed for 2-12 hours inside these layers. The lithium ion conductivity of these solid-state electrolytes was measured. The lithium ion conductivity of diethyl vinylphosphonate derived polymers was found to be in the range of 5.4×10⁻⁵ S/cm−7.3×10⁻⁴ S/cm and that of diisopropyl vinylphosphonate polymer electrolytes in the range of 6.6×10⁻⁵ S/cm−8.4×10⁻⁴ S/cm without a second solvent. Both are solid state electrolytes that are highly flame resistant. The presence of phosphazene liquid was found to increase the lithium ion conductivity by 3-5 times.

Multiple positive electrodes, layers of polymer electrolyte separator, and negative electrodes were stacked to form battery modules. Multiple modules were then internally connected in parallel to make a battery pack, which was encased in plastic-Al-plastic housing. In several samples, a garnet-type solid electrolyte (Li₇La₃Zr₂O₁₂(LLZO) powder) was added into the cathode (NCM-532) in the anode-less lithium battery.

1. A lithium battery pack, comprising one or more than one battery module wherein said module comprises a plurality of unit cells that are internally connected in series, wherein:
(A)each unit cell comprises a positive electrode (PE), a negative electrode (NE), an ion-conducting separator layer (SL) disposed between the positive electrode (cathode) and the negative electrode (anode);
(B) the positive electrode comprises (i) a cathode current collector (CCC) comprising a first conductive material foil having a thickness from 10 nm to 100 μm and two opposing primary surfaces, herein referred to as a first primary surface and a second primary surface, respectively; and (ii) a cathode active layer (CAL) deposited on the first primary surface and in physical or ionic contact with the separator, wherein the positive electrode layer comprises a mixture of particles of a cathode active material, a conductive additive, and a first polymer electrolyte having a lithium salt dispersed therein, which is a solid polymer electrolyte or gel polymer electrolyte, having a lithium ion conductivity no less than 1.0×10⁻⁸ S/cm at room temperature; and
(C) the negative electrode comprises (iii) an anode current collector (ACC) comprising a second conductive material foil having a thickness from 10 nm to 100 μm and two opposing primary surfaces, herein referred to as a third primary surface and a fourth primary surface, respectively; and (iv) an optional anode active layer (AAL), deposited on the third primary surface and in physical or ionic contact with the separator, comprising a lithium metal layer or a layer of a mixture of particles of an anode active material, a second polymer electrolyte having a lithium salt dispersed therein, which is different than or the same as the first polymer electrolyte and is a solid polymer electrolyte or gel polymer electrolyte having a lithium ion conductivity no less than 1.0×10⁻⁸ S/cm at room temperature.

2. The lithium battery pack of claim 1, wherein the battery pack comprise multiple modules that are internally connected in parallel to form the pack.

3. The lithium battery pack of claim 1, wherein the positive electrode layer, the negative electrode layer, or the ion-conductive separator layer comprises particles of an inorganic solid-state electrolyte and/or particles of a ceramic or glass material.

4. The lithium battery pack of claim 3, wherein said inorganic solid electrolyte is selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof and wherein the particles of ceramic or glass material is selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

5. The lithium battery pack of claim 1, wherein the first or second polymer electrolyte comprises a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

6. The lithium battery pack of claim 1, wherein the ion-conducting separator layer is selected from a porous polymer membrane, a nonwoven fabric, a polymer electrolyte, an inorganic solid-state electrolyte, a polymer composite electrolyte comprising particles of an inorganic solid-state electrolyte dispersed in a polymer matrix, or a polymer composite electrolyte comprising particles of a ceramic or glass material dispersed in a polymer matrix.

7. The lithium battery pack of claim 6, wherein the particles of ceramic or glass material is selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, x=0-1, y=1-4.

8. The lithium battery pack of claim 1, wherein the first or second polymer electrolyte comprises a liquid solvent being held by or dispersed in the first or second polymer and wherein the liquid solvent is selected from the group consisting of 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, dimethyl carbonate (DMC), methylethyl carbonate (MEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), vinylene carbonate, ethylene carbonate, fluoroethylene carbonate, vinyl sulfite, vinyl ethylene sulfite, vinyl ethylene carbonate, 1,3-propyl sultone, 1,3-acrylic-sultones, methyl ethylene sulfone, methyl vinyl sulfone, ethyl vinyl sulfone, methyl methacrylate, vinyl acetate, acrylamide, 1,3-dioxolane (DOL), fluorinated ethers, fluorinated esters, sulfones, sulfides, nitriles, sulfates, siloxanes, silanes, phosphates, phosphonates, phosphinates, phosphines, phosphine oxides, phosphonic acids, phosphorous acid, phosphites, phosphoric acids, phosphazene compounds, derivatives thereof, ionic liquids, and combinations thereof. (The liquid solvent-to-polymer weight ratio is preferably from 1/100 to 30/100 in the first polymer electrolyte or second polymer electrolyte.)

9. The lithium battery pack of claim 1, wherein the positive electrode layer, the negative electrode layer, or the ion-conductive separator layer comprises a flame retardant selected from an organic phosphorus compound, an inorganic phosphorus compound, a halogenated derivative thereof, or a combination thereof.

10. The lithium battery pack of claim 9, wherein the organic phosphorus compound or the inorganic phosphorus compound is selected from the group consisting of phosphates, phosphonates, phosphonic acids, phosphorous acids, phosphites, phosphoric acids, phosphinates, phosphines, phosphine oxides, phosphazene compounds, derivatives thereof, and combinations thereof.

11. The lithium battery pack of claim 3, wherein said first or second solid polymer or gel polymer electrolyte and said inorganic solid-state electrolyte, in combination, form a contiguous phase in the positive electrode, the negative electrode, or both the negative and positive electrodes, and the contiguous phase is in a physical contact or ionic communication with said ion-conducting separator layer.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A method of producing the battery pack of claim 1, the method comprising (a) preparing multiple positive electrodes each comprising a cathode active layer supported by a cathode current collector, multiple ion-conducting separators, and multiple negative electrodes each comprising an optional anode active layer supported by an anode current collector, wherein at least one of the cathode active layer, the anode active layer, and the separator comprises a polymer electrolyte or a polymer composite electrolyte; (b) stacking the positive electrodes, separators and negative electrodes sequentially to form a battery stack comprising multiple unit cells internally connected in series; (c) exerting a pressure along a stacking direction or a pressure and heat to the battery stack to form a module; and (d) optionally encasing the module with a protective housing member to form a pack.

27. The method of claim 26, wherein step (a), step (b) and step (c) are repeated to form multiple modules and the method further comprises internally connecting the resulting multiple modules in parallel, and step (d) comprises encasing the parallel-connected multiple modules with a protective housing member to form a pack.

28. A method of producing the battery pack of claim 1, wherein the method comprises stacking pack components in at least one of the following three sequences: (i) layer-by-layer, (ii) electrode-separator-electrode, and (iii) cell-by-cell sequences.

29. The lithium battery pack of claim 1, wherein the positive electrode layer further includes a binder resin.

30. The lithium battery pack of claim 1, wherein the negative electrode layer further includes a conductive additive and a binder resin.

31. The lithium battery pack of claim 1, further including a protective housing member that encloses the one or more than one module.
